(19) United States
(12) Patent Application Publication
(10) Pub. No.: US 2014/0077608 A1
(43) Pub. Date: Mar. 20, 2014

(54) POWER GENERATION CONTROL DEVICE, PHOTOVOLTAIC POWER GENERATION SYSTEM AND POWER GENERATION CONTROL METHOD

(71) Applicant: PANASONIC CORPORATION, Osaka (JP)

(72) Inventors: Shigekiyo NOSAKA, Fukuoka (JP); Kazuhiro YANAGI, Fukuoka (JP)

(73) Assignee: PANASONIC CORPORATION, Osaka (JP)

(21) Appl. No.: 14/029,514

(22) Filed: Sep. 17, 2013

(30) Foreign Application Priority Data
Sep. 18, 2012 (JP) 2012-205076
Sep. 18, 2012 (JP) 2012-205077
Sep. 18, 2012 (JP) 2012-205078

(51) Int. Cl. H02J 1/10

(52) U.S. Cl. CPC H02J 1/102
USPC 307/77; 307/82

(57) ABSTRACT

A power generation control device is electrically connected to a photovoltaic panel for controlling an output voltage of the photovoltaic panel. The power generation control device includes a scanning unit, configured to perform a scanning process in which the output voltage of the photovoltaic panel is sequentially changed in a predetermined voltage range. The predetermined voltage range is changed in accordance with the photovoltaic panel.

### BACKGROUND

1. Technical Field

The present invention relates to a power generation control device, a photovoltaic power generation system, a power generation control method, a control device, and a control method.

2. Background Art

In recent years, photovoltaic power generation of converting solar energy into electric energy using a photovoltaic (PV) panel has been spread widely for conventional use. The photovoltaic power generation has recently particularly attracted attention because waste materials, waste water, noise, vibration, and the like are not generated at the time of power generation and thus the photovoltaic power generation is expected to be commercially used as an emergency power source.

The power generation capacity of a photovoltaic panel depends on, for example, solar irradiance and weather (for example, temperature and cloudiness). In order to maximize the power generated in the photovoltaic power generation, maximum power point tracking (MPPT) control (hereinafter, also referred to as MPPT control) is carried out.

As an example of a device for performing the MPPT control, a photovoltaic power generation system in which plural photovoltaic cell arrays or modules having different output characteristics are connected in series to each other and plural local maximum points of output power thereof are present is known (for example, see JP-A-2011-008348).

In such a photovoltaic power generation system, an operating voltage is changed by a voltage range of a predetermined step size from any one of an open voltage and a minimum voltage as a start point to an upper limit voltage of the minimum voltage or the open voltage. All of the local maximum points of the output power are detected and then the operating voltage is changed in a voltage range of a predetermined step size from a turning point with the upper limit voltage as the turning point. The power is controlled to go to the maximum power point having the maximum power out of the detected local maximum points.

As another example of the device for performing the MPPT control, a photovoltaic array in which plural strings in which plural photovoltaic modules receiving sunlight and generating power are connected in series are connected in parallel is disclosed (for example, see JP-A-2011-008348). Each string includes the photovoltaic modules that are connected in series and power control devices that are connected to the photovoltaic modules and that adjust output voltage values and output current values of the photovoltaic modules. Each power control device calculates the maximum power value at the maximum power point of the maximum power point tracking control in the corresponding photovoltaic module.

### SUMMARY

In such a photovoltaic power generation system, since the voltage is sequentially changed (i.e., scanned) from the minimum voltage of the photovoltaic, panel to the open voltage, it takes time to search for the maximum power point. In addition, during the scanning, the output current or the output voltage of the photovoltaic panel greatly varies, whereby electrical appliances connected to the photovoltaic power generation system often do not normally operate.

In the photovoltaic power generation system, there is a possibility that power generation efficiency of the PV panel is not sufficient.

The present invention provides a power generation control device, a photovoltaic power generation system, and a power generation control method which can rapidly search for a maximum power point and suppress a variation in output of a photovoltaic panel.

The present invention also provides a photovoltaic power generation system, a power generation control device, a control device, a power generation control method, and a control method which can improve power generation efficiency of a PV panel.

An aspect of the present invention provides a power generation control device to be electrically connected to a photovoltaic panel for controlling an output voltage of the photovoltaic panel, the power generation control device including a scanning unit, configured to perform a scanning process in which the output voltage of the photovoltaic panel is sequentially changed in a predetermined voltage range, wherein the predetermined voltage range is changed in accordance with the photovoltaic panel.

Another aspect of the present invention provides a photovoltaic power generation system including a power generation control device for controlling a photovoltaic panel, and a control device for controlling the power generation control device. The control device is configured to transmit a start request to the power generation control device, wherein the start request is provided to request the power generation control device to perform a scanning process in which an output voltage of the photovoltaic panel is sequentially changed. The power generation control device includes a receiving unit, configured to receive the start request from the control device, and a scanning unit, configured to perform the scanning process in a predetermined voltage range in response to the start request, wherein the predetermined voltage range is changed in accordance with the photovoltaic panel.

Still another aspect of the present invention provides a power generation control method in a power generation control device including performing a scanning process in which an output voltage of a photovoltaic panel is sequentially changed in a predetermined voltage range, wherein the predetermined voltage range is changed in accordance with the photovoltaic panel.

According to the aspect as mentioned above, it is possible to rapidly search for a maximum power point and to suppress a variation in output of a photovoltaic panel.

According to the aspect as mentioned above, it is possible to improve power generation efficiency of a PV panel.

### BRIEF DESCRIPTION OF THE DRAWINGS

FIG. 1 is a block diagram illustrating a configuration example of a photovoltaic power generation system according to a first embodiment of the present invention.

FIG. 2 is a block diagram illustrating a configuration example of an MPPT slave device in the first embodiment of the present invention.

FIG. 3 is a diagram partially illustrating a detailed configuration example of the MPPT slave device in the first embodiment of the present invention.

FIG. 4 is a block diagram illustrating a configuration example of an MPPT master device in the first embodiment of the present invention.

FIG. 5 is a diagram illustrating a peripheral configuration example of a PV panel in the first embodiment of the present invention.

FIG. 6A is a diagram schematically illustrating a configuration example of the PV panel in a non-shadowed state in the first embodiment of the present invention and FIG. 6B is a diagram illustrating an example of an IV characteristic and a PV characteristic of the PV panel in a non-shadowed state.

FIG. 7A is a diagram schematically illustrating a configuration example of the PV panel in a state where a photovoltaic cell is shadowed in the first embodiment of the present invention and FIG. 7B is a diagram illustrating an example of an IV characteristic and a PV characteristic of the PV and in a state where a photovoltaic cell is shadowed.

FIG. 8A is a diagram schematically illustrating a configuration example of the PV panel in a state where three photovoltaic cells are shadowed in the first embodiment of the present invention and FIG. 8B is a diagram illustrating an example of an IV characteristic and a PV characteristic of the PV panel in a state where three photovoltaic cells are shadowed.

FIG. 9A is a diagram schematically illustrating a configuration example of the PV panel in a state where a shadow pole is present in the first embodiment of the present invention and FIG. 9B is a diagram illustrating an example of an IV characteristic and a PV characteristic of the PV panel in a state where a shadow pole is present.

FIG. 10 is a diagram illustrating an example of a PV characteristic of the PV panel depending on a shadow state in a photovoltaic power generation system in which three bypass diodes are disposed in the first embodiment of the present invention.

FIG. 11 is a diagram illustrating an example of a PV characteristic of the PV panel depending on a shadow state in a photovoltaic power generation system in which two bypass diodes are disposed in the first embodiment of the present invention.

FIG. 12 is a flowchart illustrating an example of a process of determining a scanning end voltage using an MPPT slave device in the first embodiment of the present invention.

FIG. 13 is a flowchart illustrating an example of a scanning process in an MPPT slave device in the first embodiment of the present invention.

FIG. 14 is a flowchart illustrating an example of the scanning process in an MPPT slave device in the first embodiment of the present invention (which is subsequent to FIG. 13).

FIG. 15 is a flowchart illustrating an example of the scanning process in an MPPT slave device in the first embodiment of the present invention (which is subsequent to FIG. 13).

FIG. 16 is a flowchart illustrating an example of the scanning process in an MPPT slave device in the first embodiment of the present invention (which is subsequent to FIGS. 14 and 15).

FIG. 17 is a diagram illustrating an example of voltages in the scanning process and a voltage range in the scanning process in the first embodiment of the present invention.

FIG. 18 is a block diagram illustrating a configuration example of a photovoltaic power generation system according to a second embodiment of the present invention.

FIG. 19 is a block diagram illustrating a configuration example of an MPPT slave device in the second embodiment of the present invention.

FIG. 20 is a diagram partially illustrating a detailed configuration example of an MPPT slave device in the second embodiment of the present invention.

FIG. 21 is a block diagram illustrating a configuration example of an MPPT master device in the second embodiment of the present invention.

FIG. 22 is a flowchart illustrating an example of a process of determining a PWM value of a string master in the second embodiment of the present invention.

FIG. 23 is a flowchart illustrating an example of the process of determining a PWM value of a string master in the second embodiment of the present invention.

FIG. 24 is a flowchart illustrating an example of the process of determining a PWM value of a string master in the second embodiment of the present invention.

FIG. 25 is a flowchart illustrating an example of the process of determining a PWM value of a string master in the second embodiment of the present invention.

FIG. 26 is a flowchart illustrating an example of the process of determining a PWM value of a string master in the second embodiment of the present invention.

FIG. 27 is a flowchart illustrating an example of a process of determining a reference voltage in the second embodiment of the present invention.

FIG. 28 is a flowchart illustrating an operation example of an MPPT slave device in the second embodiment of the present invention.

FIG. 29A is a diagram illustrating an example of a PV characteristic when an MPPT slave device in the second embodiment of the present invention fixes a PWM value, FIG. 29B is a diagram illustrating an example of a PV characteristic when an MPPT slave device in the second embodiment of the present invention raises a voltage in MPPT control, and FIG. 29C is a diagram illustrating an example of a PV characteristic when an MPPT slave device in the second embodiment of the present invention lowers a voltage in MPPT control.

FIG. 30A is a diagram illustrating an example of a PV characteristic when a power conditioner in the second embodiment of the present invention performs MPPT control, FIG. 30B is a diagram illustrating an example of a PV characteristic when a string including one string master ST of which the PWM value is raised and fixed and five MPPT slave devices subjected to MPPT control is seen from the power conditioner in the second embodiment of the present invention, and FIG. 30C is a diagram illustrating an example of a PV characteristic when a string including one string master of which the PWM value is lowered and fixed and five MPPT slave devices subjected to MPPT control is seen from the power conditioner in the second embodiment of the present invention.

FIG. 31A is a diagram illustrating an IV (current-voltage) characteristic of a PV panel when an MPPT unit does not perform MPPT control, FIG. 31B is a diagram illustrating a PV (power-voltage) characteristic of a PV panel when an MPPT unit does not perform MPPT control, and FIG. 31C is a diagram illustrating an ideal PV characteristic of a PV panel when an MPPT unit performs MPPT control.

FIG. 32A is a diagram illustrating a PV characteristic of a PV panel when the PV panel is seen from the power conditioner where the power conditioner does not perform MPPT control and FIG. 32B is a diagram illustrating an ideal PV characteristic of a PV panel when the PV panel is seen from the power conditioner where the power conditioner performs MPPT control.

FIG. 33 is a diagram illustrating a PV characteristic including a conversion loss when the power conditioner performs MPPT control and a PV characteristic recognized by the power conditioner.

### DETAILED DESCRIPTION

Hereinafter, embodiments of the present invention will be described with reference to the accompanying drawings.

### First Embodiment

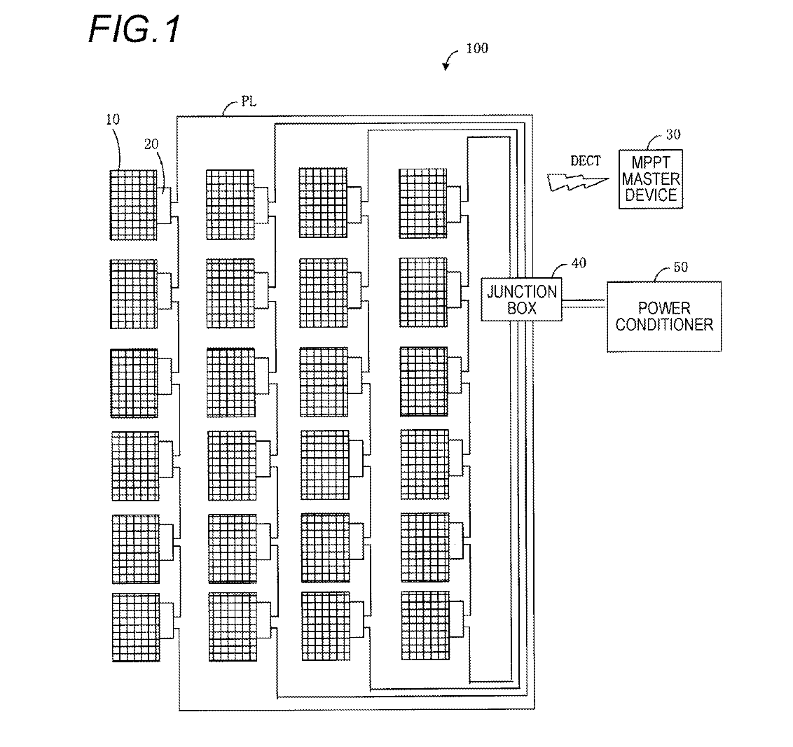

FIG. 1 is a diagram illustrating a configuration example of a photovoltaic power generation system 100 according to a first embodiment of the present invention. The photovoltaic power generation system 100 includes photovoltaic (PV) panels 10, MPPT slave devices 20, an MPPT master device 30, a junction box 40, and a power conditioner 50. Each MPPT slave device 20 is an example of the power generation control device. The MPPT master device 30 is an example of the control device.

A PV panel 10 is a panel including photovoltaic cells that converts optical energy into electric power using a photoelectric conversion effect. The PV panel 10 may be a single photovoltaic cell or a photovoltaic cell module in which plural photovoltaic cells are combined. The PV panels 10 are connected in series or in parallel to power lines PL. The PV panels 10 are associated with the MPPT slave devices 20 in a one-to-one manner.

In the example shown in FIG. 1, the PV panels 10 are connected in series by a power line PL to constitute a photovoltaic string (PV string). The photovoltaic strings are connected in parallel to the junction box 40 by the power lines PL to constitute a photovoltaic array (PV array). Six PV panels 10 are connected in series to constitute a PV string, and four PV strings are connected in parallel to constitute a PV array. The number of PV panels and the number of PV strings are not limited to this example.

Each MPPT slave device 20 controls power generated in the PV and 10 connected thereto. That is, the MPPT slave device 20 receives the power generated in the PV panel 10 connected thereto and controls the generated power to be a desired power. The desired power may vary by the MPPT slave devices 20, for example, depending on the directions of the PV panels 10, the installation location of the PV panels 10, or the sunshine conditions.

For example, each MPPT slave device 20 performs MPPT control on the PV panel 10 connected thereto. The MPPT control of the MPPT slave device 20 is a control for maximizing the amount of power generated in the PV panel connected thereto. The MPPT control can be realized using a known method and, for example, a hill-climbing method can be employed. The MPPT slave device 20 serves as a slave unit of the MPPT master device 30.

The MPPT master device 30 serves as a master unit of plural MPPT slave devices 20. For example, the MPPT master device 30 receives values (for example, a measured value of current, voltage, or power) measured by the MPPT slave devices 20 from the MPPT slave devices 20 and normally monitors the amounts of power generated in the PV panels 10.

The installation place of the MPPT master device 30 is not particularly limited. For example, the MPPT master device 30 may be installed as an independent device in a place in which it can communicate with the MPPT slave devices 20, may be installed in the power conditioner 50, or may be installed in the junction box 40. In FIG. 1, the MPPT master device 30 is installed as an independent device.

The junction box 40 collectively concentrates the power lines PL as wires in the unit of PV strings in which plural PV panels 10 are connected in series and connects the power lines PL to the power conditioner 50. The junction box 40 includes, for example, terminals for connection to the power lines PL, switches used for check or maintenance, a lightning arrestor element, and a backflow preventing diode for preventing a backflow of electricity.

The junction box 40 may be integrated with the power conditioner 50. The junction box 40 may be omitted.

The power conditioner 50 converts DC power output from the junction box 40 (DC-DC conversion) and converts the DC power into AC power again (DC-AC conversion). The power conditioner 50 is connected to, for example, a power distribution board (not illustrated in the drawing).

The power conditioner 50 performs MPPT control on the power input from the power conditioner 50 in the DC-DC conversion. The MPPT control of the power conditioner 50 is a control for maximizing the total amount of power generated from the PV panels 10 included in the photovoltaic power generation system 100. The MPPT control can be realized using a known method and, for example, a hill-climbing method can be employed.

The configuration example of an MPPT slave device 20 will be described below.

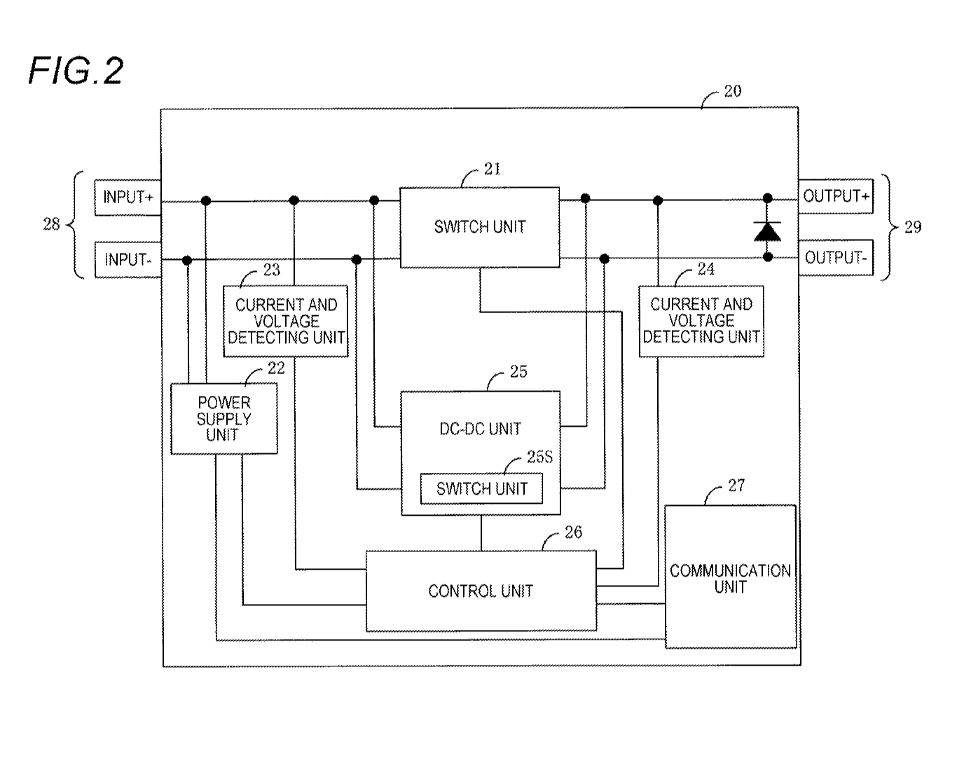

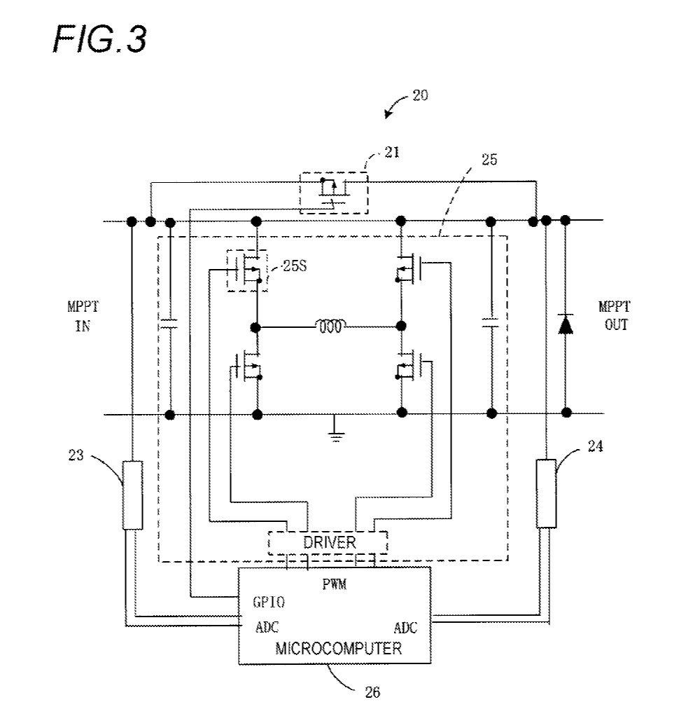

FIG. 2 is a diagram illustrating the configuration example of an MPPT slave device 20. FIG. 3 is a diagram partially illustrating the detailed configuration example of the MPPT slave device 20. The MPPT slave device 20 includes a switch unit 21, a power supply unit 22, current and voltage detecting units 23 and 24, a DC-DC unit 25, a control unit 26, a communication unit 27, an input terminal 28, and an output terminal 29.

The switch unit 21 electrically connects or disconnects the input terminal 28 and the output terminal 29 of the MPPT slave device 20 to and from each other. The ON and OFF states of the switch unit 21 are controlled in response to a switching signal from the control unit 26.

When the input terminal 28 and the output terminal 29 are electrically connected to each other (ON state), the power from the PV panel 10 connected to the MPPT slave device 20 is made to pass to the output terminal 29 without any change. Accordingly, it is possible to monitor the output of the PV panel 10.

When the input terminal 28 and the output terminal 29 are electrically disconnected from each other (OFF state), the power from the PV panel 10 connected to the MPPT slave device 20 is not output through the path passing through the switch unit 21.

The power supply unit 22 is supplied with power from the PV panel 10 and supplies the power to the constituent units of the MPPT slave device 20.

The current and voltage detecting unit 23 detects an output current and an output voltage of the PV panel 10. That is, the current and voltage detecting unit 23 detects the current value and the voltage value before the DC-DC unit 25 converts the voltage. The current detected by the current and voltage detecting unit 23 is also referred to as input-side detected current and the voltage detected by the current and voltage detecting unit 23 is also referred to as input-side detected voltage.

The current and voltage detecting unit 24 detects an output current and an output voltage of the switch unit 21 or the DC-DC unit 25. That is, the current and voltage detecting unit 24 detects the current value and the voltage value passing through the switch unit 21 or the current value and the voltage value after the DC-DC unit 25 converts the voltage. The current detected by the current and voltage detecting unit 24 is also referred to as output-side detected current and the voltage detected by the current and voltage detecting unit 24 is also referred to as output-side detected voltage.

The DC-DC unit 25 is a DC/DC converter and includes a switch unit 25S having a power-conversion switching element. The switch unit 25S controls the power supplied from the PV panel 10 via the power line PL by appropriately switching the ON and OFF states thereof.

The DC-DC unit 25 receives the output voltage of the PV panel 10 and converts the input voltage using the switch unit 25S. The ON and OFF states of the switch unit 25S are controlled in response to a PWM (Pulse Width Modulation) signal from the control unit 26.

The control unit 26 performs various processes, for example, by causing a microcomputer to execute a program stored in a ROM not shown in the drawing.

When performing the MPPT control, the control unit 26 determines a duty cycle (PWM value) indicating a ratio of the ON time and the OFF time of the switch unit 25S of the DC-DC unit 25 so that the output-side detected voltage is a predetermined voltage, and controls the ON and OFF states of the switch unit 25S. For example, the predetermined voltage is a voltage of a maximum power point which is determined through the MPPT control. In the MPPT control, the duty cycle is variable.

The control unit 26 has a function as a scanning unit that performs a scanning process to be described later. In the scanning process, the output voltage of the PV panel 10 is sequentially changed in a predetermined voltage range to acquire a PV (Power-Voltage) characteristic indicating the relationship between the output voltage and the output power of the PV panel 10.

The output voltage of the PV panel 10 is detected as the input-side detected voltage of the MPPT slave device 20. The output current of the PV panel 10 is detected as the input-side detected current of the MPPT slave device 20. The output power of the PV panel 10 is a product of the input-side detected voltage and the input-side detected current detected by the MPPT slave device 20. The MPPT slave device 20 may include a power detector that detects the input-side power.

The control unit 26 has a function of a local maximum power point estimating unit that estimates a maximum power point from the PV characteristic. The control unit 26 performs a process of determining a scanning end voltage which is a voltage at which the scanning process to be described later ends.

The communication unit 27 communicates with another MPPT slave device 20, the MPPT master device 30, or the power conditioner 50 in a wired or wireless manner. Examples of this communication method include power line communication (PLC) using a power line, DECT (Digital Enhanced Cordless Telecommunication), or Zigbee (registered trademark).

For example, the communication unit 27 transmits detection information including the values detected by the current and voltage detecting units 23 and 24 to the MPPT master device 30. The detection information includes, for example, the input-side detected current value and the input-side detected voltage value. The detection information may include the output-side detected current value and the output-side detected voltage value in addition to the input-side information.

For example, the communication unit 27 receives a scanning process start request from the MPPT master device 30. The communication unit 27 receives a desired value of the scanning end voltage.

The configuration example of the MPPT master device 30 will be described below.

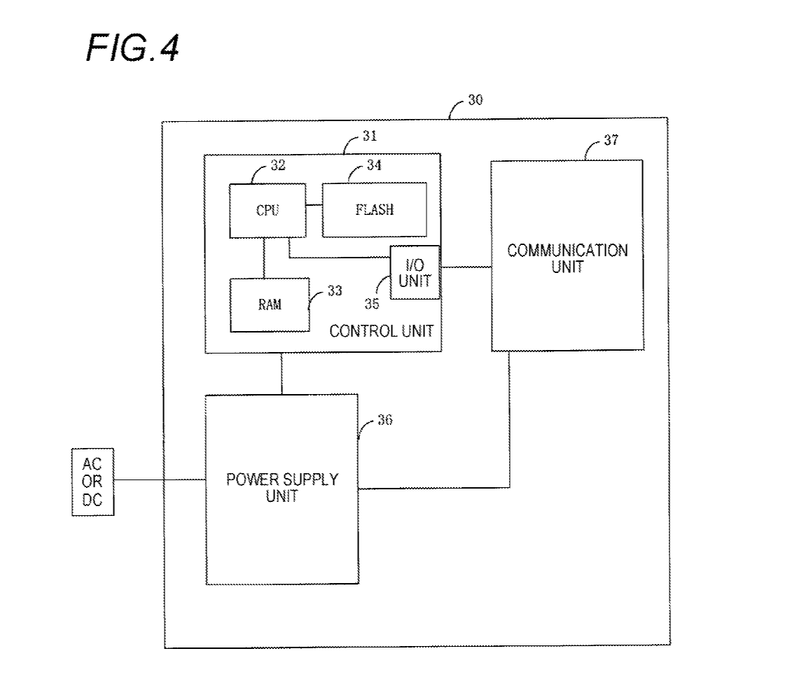

FIG. 4 is a diagram illustrating the configuration example of the MPPT master device 30. The MPPT master device 30 includes a control unit 31, a power supply unit 36, and a communication unit 37. The control unit 31 includes a CPU (Central Processing Unit) 32, a RAM (Random Access Memory) 33, a flash memory (Flash) 34, and an I/O (Input/Output) unit 35.

The control unit 31 performs various processes, for example, by causing the CPU 32 to execute a program stored in the RAM 33. The processing result of the control unit 31 is transmitted to another device, for example, via the I/O unit 35 by the communication unit 37. The I/O unit 35 is a communication interface between the control unit 31 and the communication unit 37 and includes, for example, a UART (Universal Asynchronous Receiver Transmitter) or an I2C (Inter Integrated Circuit).

The power supply unit 36 is supplied with power, for example, from a commercial power supply (AC power supply or DC power supply) and supplies the power to the constituent units of the MPPT master device 30.

The communication unit 37 communicates with the MPPT slave devices 20 in a wired or wireless manner. Examples of this communication method include power line communication (PLC) using a power line, DECT (Digital Enhanced Cordless Telecommunication), or Zigbee (registered trademark).

For example, the communication unit 37 receives detection information from the MPPT slave devices 20. The communication unit 37 transmits a scanning process start request to the MPPT slave devices 20. The communication unit 37 transmits a desired value of the scanning end voltage to the MPPT slave devices 20.

The power conditioner 50 includes, for example, a DC/DC converter, a control unit for performing MPPT control, a communication unit for communication with another device, and a DC/AC converter.

The peripheral configuration example of a PV panel 10 will be described below.

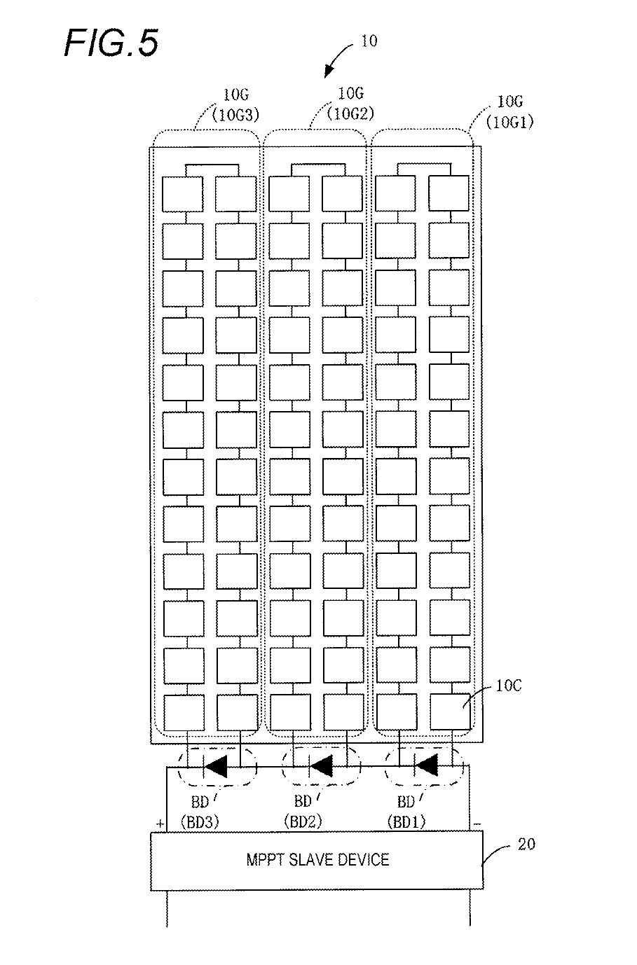

FIG. 5 is a diagram illustrating the peripheral configuration example of a PV panel 10.

A PV panel 10 includes plural photovoltaic cell groups 10G. Each photovoltaic cell group 10G includes plural photovoltaic cells 10C. The plural photovoltaic cells 10C included in each photovoltaic cell group 10G are connected in series. Bypass diodes BD (BD1 to BD3) are connected in parallel to the photovoltaic cell groups 10G (10G1 to 10G3), respectively. In FIG. 5, three photovoltaic cell groups 10G and three bypass diodes are disposed, but the number of photovoltaic cell groups and the number of bypass diodes are not limited to this example.

When no defect occurs in the photovoltaic cells 10C, the respective photovoltaic cell groups 10G generate power and thus a voltage is generated therefrom. Accordingly, since a backward voltage is applied to the bypass diodes BD, the bypass diodes BD do not transmit a current.

On the other hand, it is assumed that a defect (for example, failure or shadow) occurs in a photovoltaic cell 10C included in a photovoltaic cell group 10G1. In this case, since the defective photovoltaic cell 10C does not generate power and serves as a simple resistor, the defective photovoltaic cell consumes energy generated from the other photovoltaic cell groups 10G2 and 10G3 and lowers the generated power of the PV panel 10.

When a current is continuously supplied to the defective photovoltaic cell 10C, the photovoltaic cell 10C may be, for example, thermally damaged. The current flowing in the photovoltaic cell group 10G including the defective photovoltaic cell 10C is passed by the bypass diode BD1 connected in parallel to the photovoltaic cell group 10G1.

The current output from the bypass diodes BD or the photovoltaic cell groups 10G is input to the MPPT slave device 20.

The output of the PV panel 10 depending on a shadow state will be described below.

Here, the MPPT slave device 20 performs a scanning process within a predetermined voltage range (for example, 0 V to 50 V). The voltage 50V is an example of the open voltage of the PV panel 10.

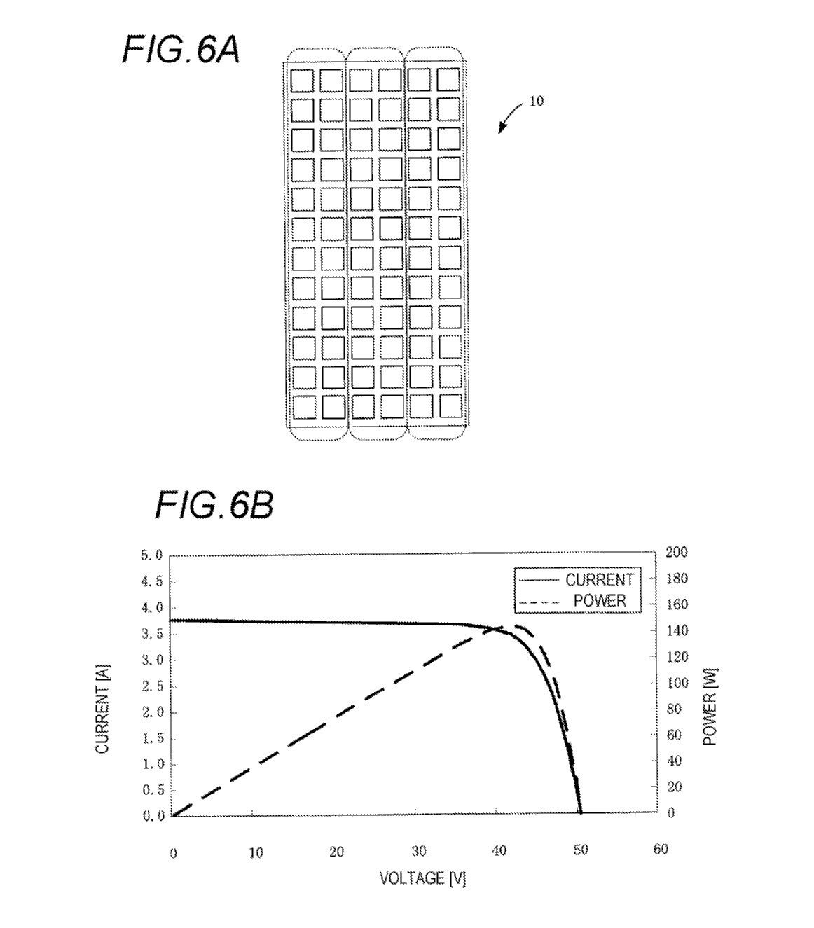

FIG. 6A is a diagram schematically illustrating a PV panel 10 in a non-shadowed state. FIG. 6B is a diagram illustrating a measurement result of the output current and the output power with respect to the output voltage of the PV panel 10 shown in FIG. 6A. In FIG. 6A, wiring between the photovoltaic cells 10C is not shown.

From FIGS. 6A and 6B, it can be understood that the output current of the PV panel 10 is about 3.7 A within the voltage range of about 0 V to 42 V. In FIGS. 6A and 6B, since a photovoltaic cell 10C serving as a load is not present, the bypass diodes BD do not pass a current. It can be understood that one local maximum power point and one maximum power point is present in the vicinity of 42 V.

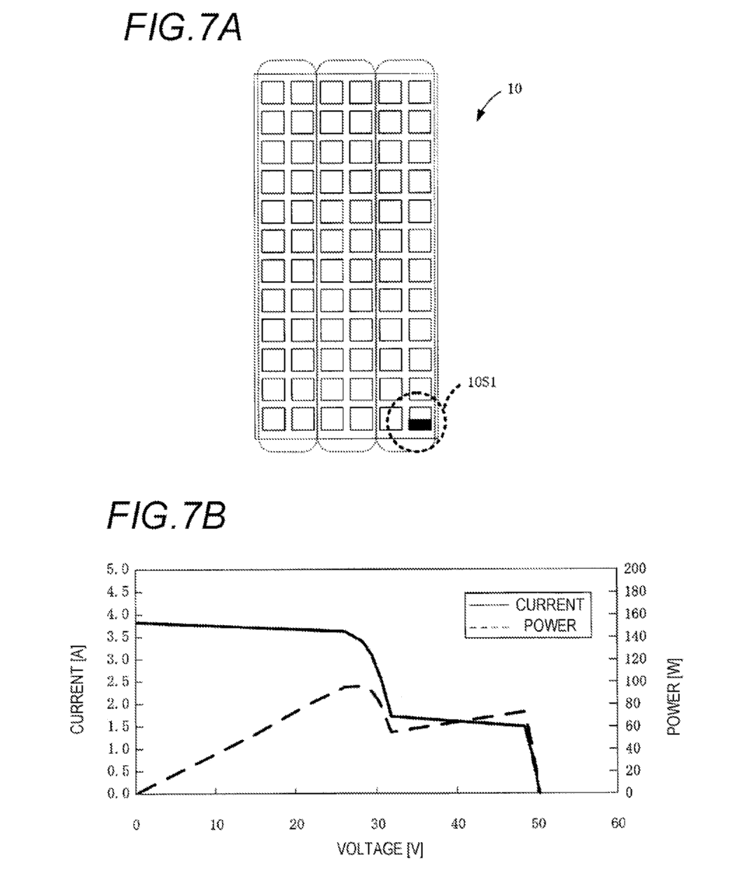

FIG. 7A is a diagram schematically illustrating a PV panel 10 in a state where a half area 10S1 of a photovoltaic cell 10C included in the photovoltaic cell group 10G1 is shadowed. In the shadowed portion, for example, light is completely blocked. FIG. 7B is a diagram illustrating a measurement result of the output current and the output power with respect to the output voltage of the PV panel 10 shown in FIG. 7A.

As shown in FIGS. 7A and 7B, since the bypass diode BD1 passes a current in the range of about 1.6 A to 3.7 A, the power (voltage) taken from the PV panel 10 is limited. For example, a voltage of about 32 V is taken at 1.6 A and a voltage of about 0 V is taken at 3.7 A. That is, the voltage taken from the PV panel 10 is limited to a range of 0 V to 32 V. In this voltage range, the same current state as in the case in which no shadow is present in FIGS. 6A and 6B is obtained.

In a range of about 0 A to 1.6 A, since the bypass diodes BD1 to BD3 do not pass a current, for example, a voltage of about 32 V is taken at 1.6 A and a voltage of about 50 V is taken at 0 A. That is, the voltage taken from the PV panel 10 is not limited by the bypass diodes BD1 to BD3.

From FIGS. 7A and 7B, it can be understood that local maximum power points are present in the vicinity of 28 V and in the vicinity of 48 V and the power point in the vicinity of 28 V is the maximum power point.

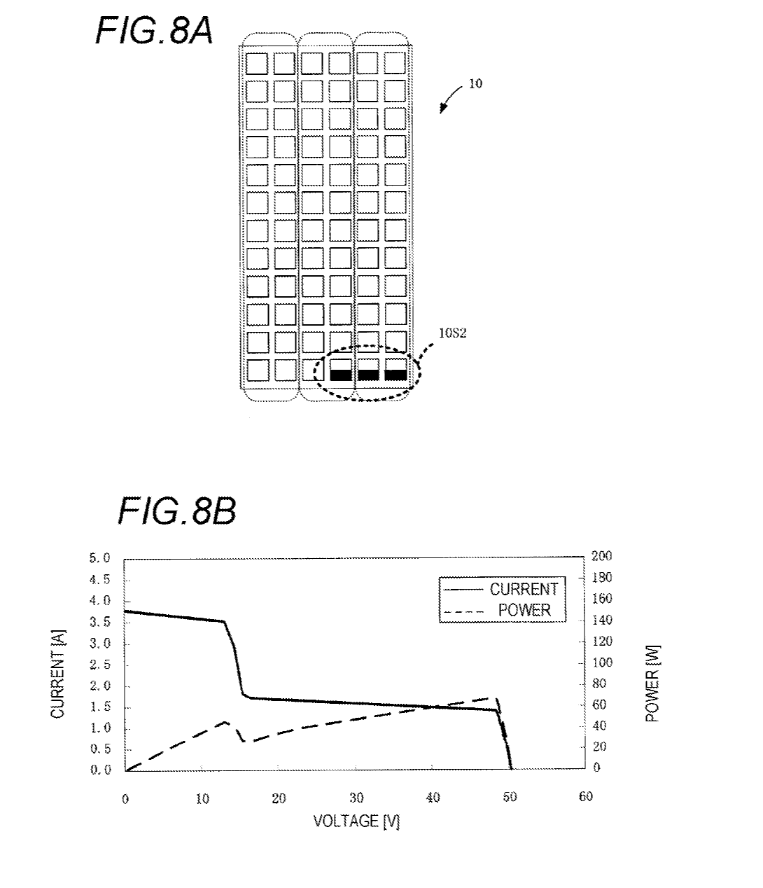

FIG. 8A is a diagram schematically illustrating a PV panel 10 in a state where an area 10S2 of a half of two photovoltaic cells 10C included in the photovoltaic cell group 10C1 and a half of one photovoltaic cell 10C included in the photovoltaic cell group 10G2 are shadowed. FIG. 8B is a diagram illustrating a measurement result of the output current and the output power with respect to the output voltage of the PV panel 10 shown in FIG. 8A.

As shown in FIGS. 8A and 8B, since the bypass diodes BD1 and BD2 pass a current in the range of about 1.6 A to 3.7 A, the power (voltage) taken from the PV panel 10 is limited. For example, a voltage of about 16 V is taken at 1.6 A and a voltage of about 0 V is taken at 3.7 A. That is, the voltage taken from the PV panel 10 is limited to a range of 0 V to 16 V. In this voltage range, the same current state as in the case in which no shadow is present in FIGS. 6A and 6B is obtained.

In a range of about 0 A to 1.6 A, since the bypass diodes BD1 to BD3 do not pass a current, for example, a voltage of about 16 V is taken at 1.6 A and a voltage of about 50 V is taken at 0 A. That is, the voltage taken from the PV panel 10 is not limited by the bypass diodes BD1 to BD3.

From FIGS. 8A and 8B, it can be understood that local maximum power points are present in the vicinity of 14 V and in the vicinity of 48 V and the power point in the vicinity of 48 V is the maximum power point.

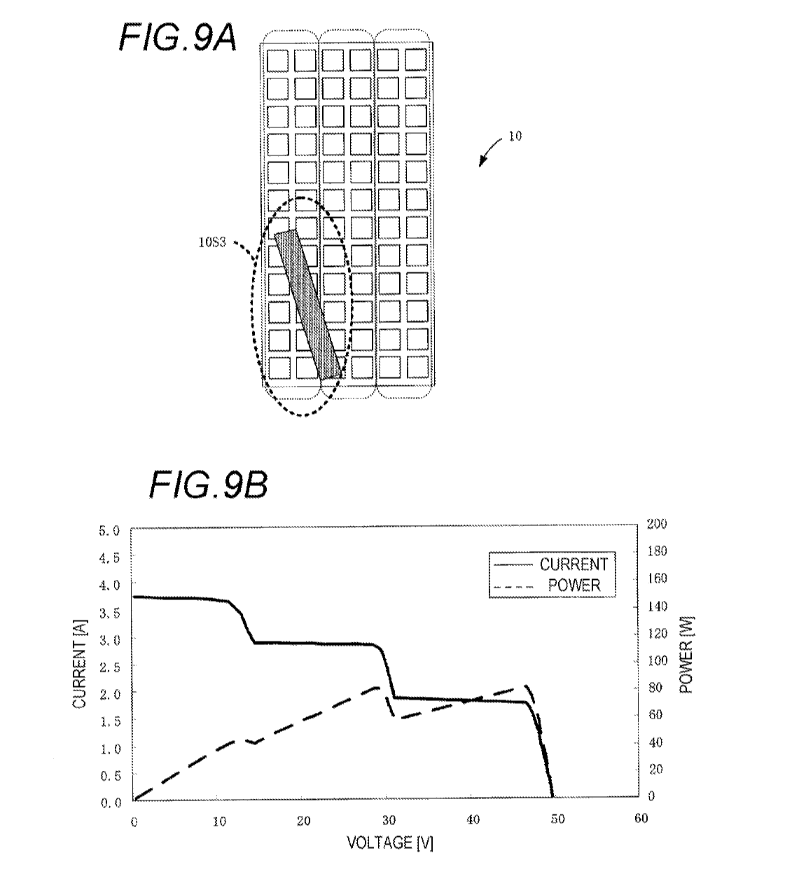

FIG. 9A is a diagram schematically illustrating a PV panel 10 in a state where a stripe-like shadow (shadow pole) is present in plural photovoltaic cells 10C located in a predetermined area 10S3 of the photovoltaic cell groups 10G2 and 10G3. FIG. 9B is a diagram illustrating a measurement result of the output current and the output power with respect to the output voltage of the PV panel 10 shown in FIG. 9A.

The stripe-like shadow (shadow pole) shown in FIG. 9A has higher light transmittance and a smaller decrease in sunshine intensity due to a shadow than the shadows shown in FIGS. 7A and 8A. Accordingly, a current flows in the photovoltaic cell groups 10G2 and 10G3 but the current value varies depending on the concentration of the shadow and the area of the shadow present in the photovoltaic cell group 10G. As a result, three local maximum points appear in the PV characteristic, as shown in FIG. 9B.

From FIGS. 9A and 9B, it can be understood that local maximum power points are present in the vicinity of 14 V, in the vicinity of 28 V, and in the vicinity of 48 V and the power point in the vicinity of 48 V is the maximum power point.

When plural local maximum power points are present, the local maximum power point having the maximum voltage is the maximum power point in the examples shown in FIGS. 7A and 7B to FIGS. 9A and 9B, but a local maximum power point not having the maximum voltage may be the maximum power point. Which local maximum power point is the maximum power point depends, for example, on the design of the PV panel 10 and it is not possible to determine the maximum power point when the MPPT slave device 20 does not perform the scanning process. The positions of the voltage at which the local maximum power points appear have regularity depending on the number of bypass diodes BD disposed in the photovoltaic power generation system 100. In the examples shown in FIGS. 7A and 7B to FIGS. 9A and 9B, the local maximum power points regularly appear in the vicinities of 14 V, 28 V, and 48 V.

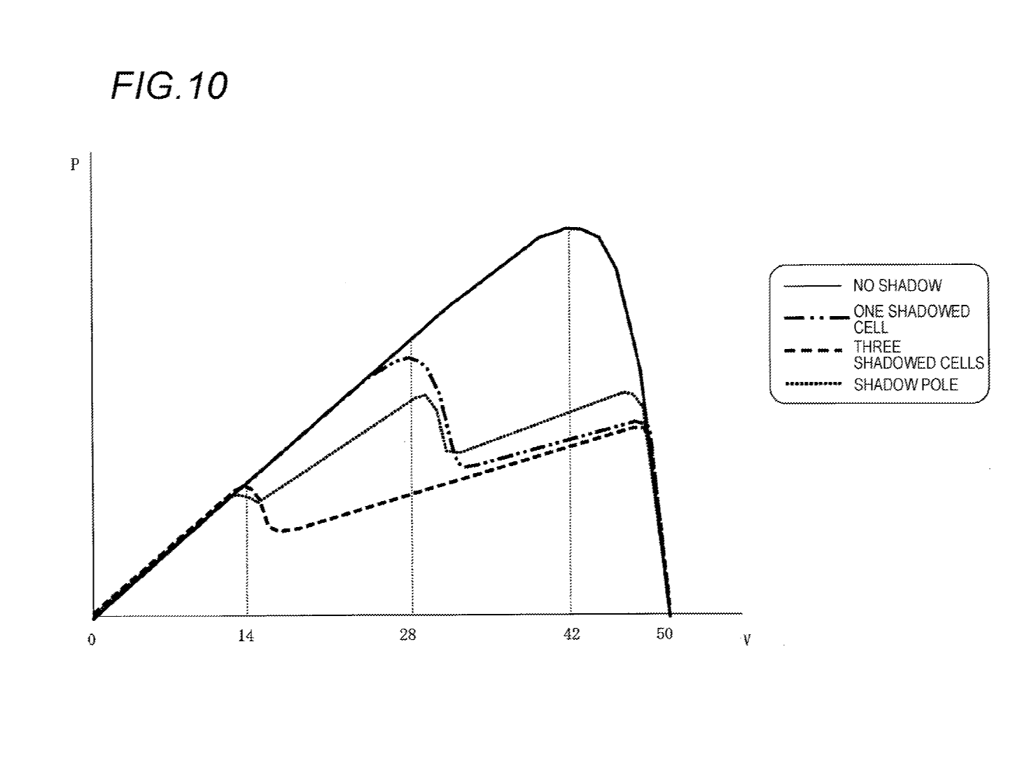

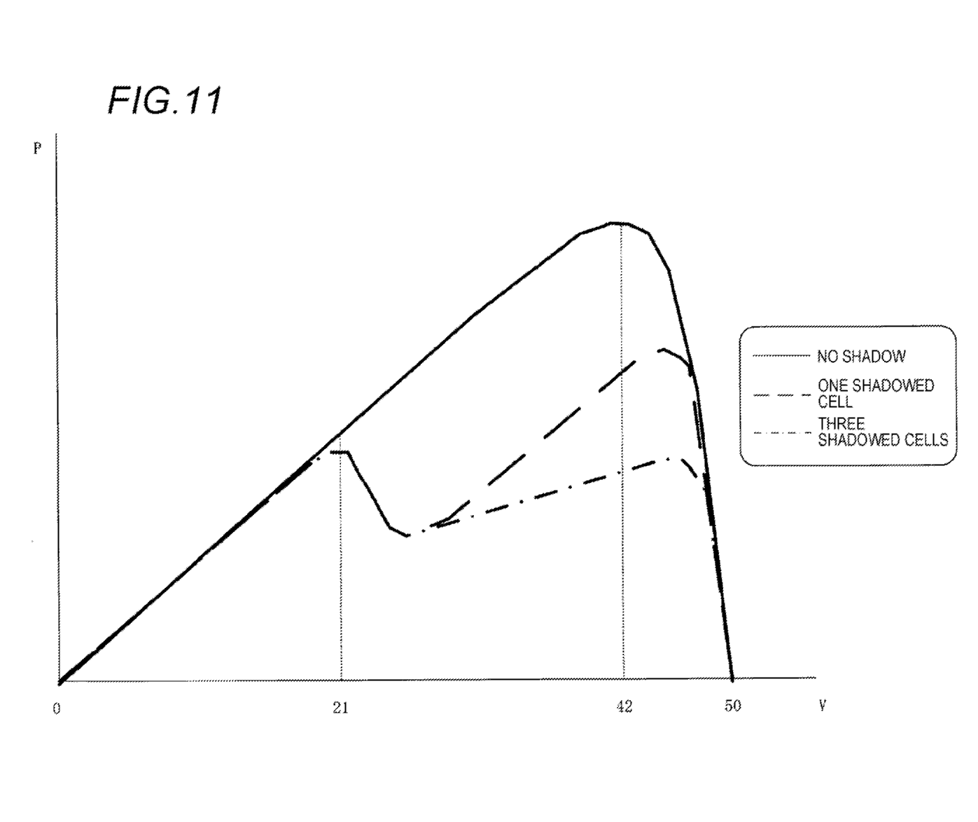

FIGS. 10 and 11 are diagrams illustrating an example of a PV (Power-Voltage) characteristic of a PV panel 10 depending on a shadow state.

FIG. 10 illustrates a PV characteristic when three bypass diodes DB are disposed. FIG. 10 shows PV characteristics in a non-shadowed state, a state where one shadowed cell is present, a state where three shadowed cells are present, and a state where a shadow pole is present.

In FIG. 10, the PV characteristic in a non-shadowed state is the same as the PV characteristic shown in FIG. 6B. The PV characteristic in the state where a shadowed cell is present is the same as the PV characteristic shown in FIG. 7B. The PV characteristic in the state where three shadowed cells are present is the same as the PV characteristic shown in FIG. 8B. The PV characteristic in the state where a shadow pole is present is the same as the PV characteristic shown in FIG. 9B.

As shown in FIG. 10, when three bypass diodes BD are disposed, three local maximum power points are present at the maximum, which depends on the way in which a shadow appears in the PV panel 10.

FIG. 11 shows the PV characteristic when two bypass diodes BD are disposed. In FIG. 11, a local maximum power point is present in the vicinity of 42 V in the non-shadowed state. When a shadow is present, the local maximum power points are present in the vicinity of 21 V and in the vicinity of 48 V.

As shown in FIG. 11, when two bypass diodes BD are disposed, two local maximum power points are present at a maximum, which depends on the way in which a shadow appears in the PV panel 10.

The PV panel 10 is designed so that about 80% of the open voltage of the PV panel 10 in a state where there is no defect is the voltage of the maximum power point. That is, when the open voltage of the PV panel 10 is 50 V, the maximum power point appears in the vicinity of 40 V (42 V in FIGS. 10 and 11) through the MPPT control. In the state where there is no defect, the number of local maximum power points is one as shown in FIGS. 10 and 11.

On the other hand, in the PV characteristic of the PV panel 10 in a state where there is a defect, plural local maximum power points are present as shown in FIGS. 10 and 11. The voltage positions of the plural local maximum power points depend on the number of bypass diodes BD. For example, when the number of bypass diodes BD is three, the local maximum power points appear at the voltage positions of 1/3 and 2/3 of the maximum power point in the state where there is a defect. When the number of bypass diodes BD is two, the local maximum power point appears at the voltage position of 1/2 of the maximum power point in the state where there is a defect.

By utilizing the regularity of the positions at which the local maximum power points appear, it is possible to limit the voltage range in which the scanning process should be performed and it is thus possible to recognize a peak portion (area) in the PV characteristic including the in maximum power point.

An operation example of an MPPT slave device 20 will be described below.

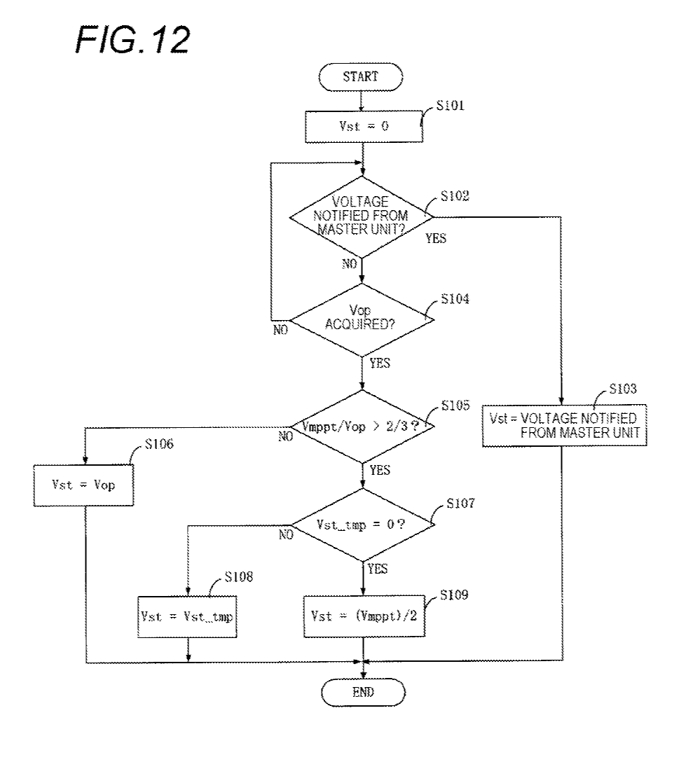

FIG. 12 is a diagram illustrating an example of a process of determining a scanning end voltage Vst in an MPPT slave device 20. The scanning end voltage Vst represents up to what voltage the scanning process should be performed from the voltage Vmppt of the set maximum power point (maximum operating point) and is a voltage at which the scanning process ends.

Here, it is assumed that the photovoltaic power generation system 100 includes two or three bypass diodes BD.

First, the control unit 26 initializes the scanning end voltage Vst, that is, sets Vst=0 (S101).

Subsequently, the control unit 26 determines whether information of a voltage is notified from the MPPT master device 30 via the communication unit 27 (S102). For example, the information on a voltage includes a value of a scanning end voltage Vst which is used in other MPPT slave devices 20 in the photovoltaic power generation system 100 or a voltage value which is designated, for example, on the basis of previous history information by the MPPT master device 30.

When the information on a voltage is notified from the MPPT master device 30, the control unit 26 sets the notified voltage as the scanning end voltage Vst (S103). When the range of the scanning process is narrowed by the notified voltage, the scanning efficiency is improved and it is thus possible to reduce the time which it takes to perform the scanning process. The MPPT master device 30 may reflect the notified voltage in the voltage range of the scanning process thereof in consideration of the PV characteristic state of other MPPT slave devices 20.

When the information on a voltage is not notified from the MPPT master device 30, the control unit 26 acquires the open voltage Vop of the PV panel 10 (S104). Since the open voltage Vop is a voltage with which the scanning process is started at the time of starting up the MPPT slave device 20, the information on a voltage may be retained. The open voltage Vop may be input via a manipulation unit (not shown) of the MPPT slave device 20. When the open voltage Vop is not acquired, the process flow goes to step S102.

When the open voltage Vop of the PV panel 10 is acquired, it is determined whether the ratio (Vmppt/Vop) of the voltage Vmppt of the maximum power point under setting to the open voltage Vop is more than a second predetermined value (for example, 2/3) (S105). The maximum power point of the PV panel 10 is generally designed to be located at a voltage position of about 80% of the open voltage Vop. It is preferable that a value in consideration of a slight margin of 80% be set as the predetermined value.

When the ratio of the voltage Vmppt of the maximum power point under setting to the open voltage Vop is equal to or less than the second predetermined value, the control unit 26 sets the open voltage Vop as the scanning end voltage Vst (S106). When the ratio is equal to or less than the second predetermined value, it means that the voltage Vmppt of the maximum power point under setting is relatively small. Through the process of step S106, the scanning process can be performed toward a higher voltage up to the open voltage Vop.

When the ratio of the voltage Vmppt of the maximum power point under setting to the open voltage Vop is more than the predetermined value, the control unit 26 determines whether a predetermined learning voltage Vst_tmp is “0” (S107). The learning voltage Vst_tmp depends on, for example, the number of bypass diodes BD. The initial value of the learning voltage Vst_tmp is “0”. When the ratio is more than the predetermined value in step S106, it means that the voltage Vmppt of the maximum power point under setting is relatively large.

When the learning voltage Vst_tmp is not “0”, the control unit 26 sets the learning voltage Vst_tmp as the scanning end voltage Vst (S108). For example, when the number of bypass diodes is three, the learning voltage is set through a predetermined process. Through the process of step S108, the scanning process can be performed toward a lower voltage up to the learning voltage Vst_tmp as a desired voltage. It is not necessary to continuously perform the scanning process up to 0 V and it is possible to reduce the time which it takes to perform the scanning process.

When the learning voltage Vst_tmp is “0”, the control unit 26 sets about a half voltage of the voltage Vmppt of the maximum power point under setting as the scanning end voltage Vst (S109). Accordingly, even when the process of determining the scanning end voltage Vst is first performed but the number of bypass diodes BD is not clear, it is possible to set a voltage range in which the scanning process can be suitably performed. It is not necessary to continuously perform the scanning process up to 0 V and it is possible to reduce the time which it takes to perform the scanning process.

For example, the following values can be considered as about the half voltage of the voltage Vmppt. As a first example, Vst=Vmppt/2−α is set. A predetermined value α is a value as a consideration result of a margin. As a second example, Vst=42 V/2=21 V is set. That is, the scanning end voltage Vst is set to a half value of the voltage Vmppt=42 V of the maximum power point under setting. As a third example, 50×0.8 (80%)×½=20 V is set. That is, the scanning end voltage Vst is set to a half value of 40 V which is estimated as the voltage of the maximum power point based on the open voltage Vop.

When the scanning end voltage Vst is set to about a half voltage of the voltage Vmppt, it is possible to suitably perform the scanning process without depending on the number of bypass diodes BD.

By employing the process of determining the scanning end voltage Vst, the scanning end voltage Vst is set to, for example, about a half of Vmppt even when the control unit 26 does not know the number of bypass diodes BD disposed in the photovoltaic power generation system 100. Therefore, even when the number of bypass diodes BD is two or three, it is possible to once determine the voltage range for the scanning process. For example, when the number of bypass diodes BD is three or more, it is possible to set the voltage range for the scanning process to be narrower than the initially-set voltage range using the learning voltage Vst_tmp.

The process of determining the scanning end voltage Vst is performed at the time of starting up the MPPT slave device 20 or at the time at which there is a possibility that the PV characteristic of the PV panel 10 varies as described below.

For example, when a predetermined period of time passes from the time point at which the process of determining the scanning end voltage Vst is previously performed, the process of determining the scanning end voltage Vst is performed.

For example, when the positions of the local maximum power points in the output of the PV panel 10 are greatly offset, the process of determining the scanning end voltage Vst is performed. When the control unit 26 sequentially retains information on the local maximum power points, it is possible to recognise the position offset of the local maximum power points.

For example, when the output power of the PV panel 10 is remarkably lowered, the process of determining the scanning end voltage Vst is performed. When the control unit 26 sequentially retains the information on the output power, it is possible to recognize the variation in the output power.

For example, when a slope of a mountain (a variation in power with respect to the voltage) in the hill-climbing method of the MPPT control varies, the process of determining the scanning end voltage Vst is performed. When the control unit 26 sequentially retains the result of the MPPT control, it is possible to recognize the variation.

For example, when the output of a panel is lower by a predetermined value than outputs (for example, output power or output voltage) of other PV panels 10, the process of determining the scanning end voltage Vst is performed. By notifying the outputs of other PV panels 10 from the MPPT master device 30, it is possible to recognize the difference from the outputs of other PV panels 10.

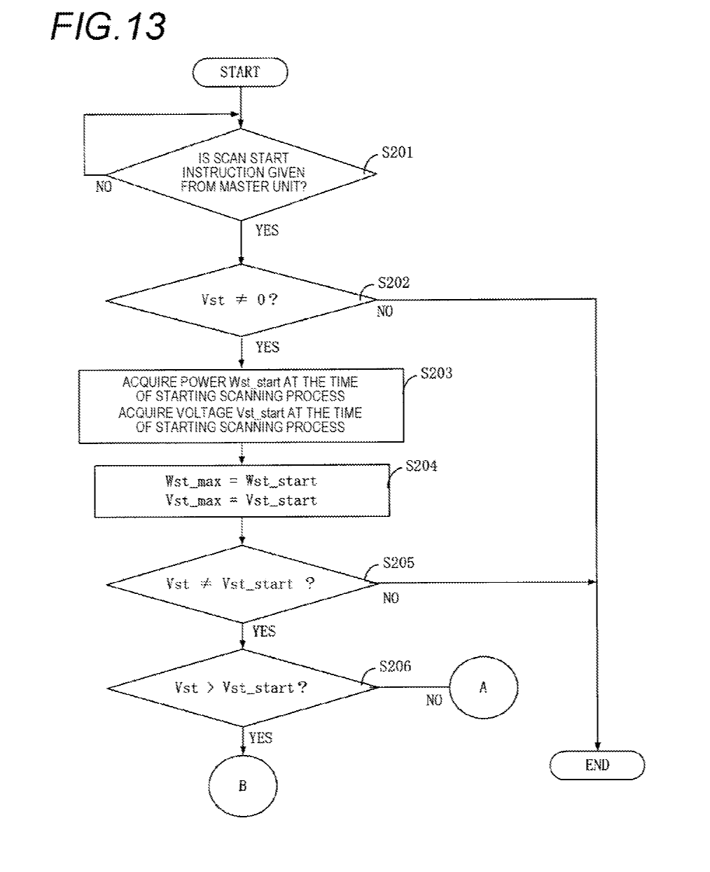

FIGS. 13 to 16 are diagrams illustrating an example of the scanning process in a MPPT slave device 20.

First, the control unit 26 determines whether a scanning process start instruction is notified from the MPPT master device 30 via the communication unit 27 (S201). The scanning process start instruction is an example of the scanning process start request.

When the scanning process start instruction is notified, the control unit 26 determines whether the scanning end voltage Vst is completely set (S202). When the scanning end voltage Vst is not determined, Vst=0 is set as the initial value thereof. When the scanning end voltage Vst is not set, the scanning process ends.

When the scanning end voltage Vst is completely set, the control unit 26 acquires the output power Wst_start of the PV panel 10 at the current time, that is, at the time of starting the scanning process, and the output voltage Vst_start of the PV panel 10 at the current time, that is, at the time of starting the scanning process (S203). Wst_start corresponds to, for example, the input-side detected power acquired by multiplying the input-side detected voltage at the time of starting the scanning process by the input-side detected current. Vst_start corresponds to, for example, the input-side detected voltage at the time of starting the scanning process.

Subsequently, the control unit 26 sets the output power Wst_start of the PV panel 10 at the time of starting the scanning process in a register Wst_max and sets the output voltage Vst_start of the PV panel 10 at the time of starting the scanning process in a register Vst_max (S204). Wst_max stores the maximum power of the PV panel 10 acquired through the scanning process. Vst_max stores the voltage at which the maximum power of the PV panel 10 acquired through the scanning process is output.

Subsequently, the control unit 26 determines whether the output voltage Vst_start of the PV panel 10 at the time of starting the scanning process is different from the scanning end voltage Vst (S205). When both are equal to each other, the scanning process ends.

When the output voltage Vst_start of the PV panel 10 at the time of starting the scanning process is different from the scanning end voltage Vst, the control unit 26 determines whether the scanning end voltage Vst is larger than the output voltage Vst_start of the PV panel 10 at the time of starting the scanning process (S206).

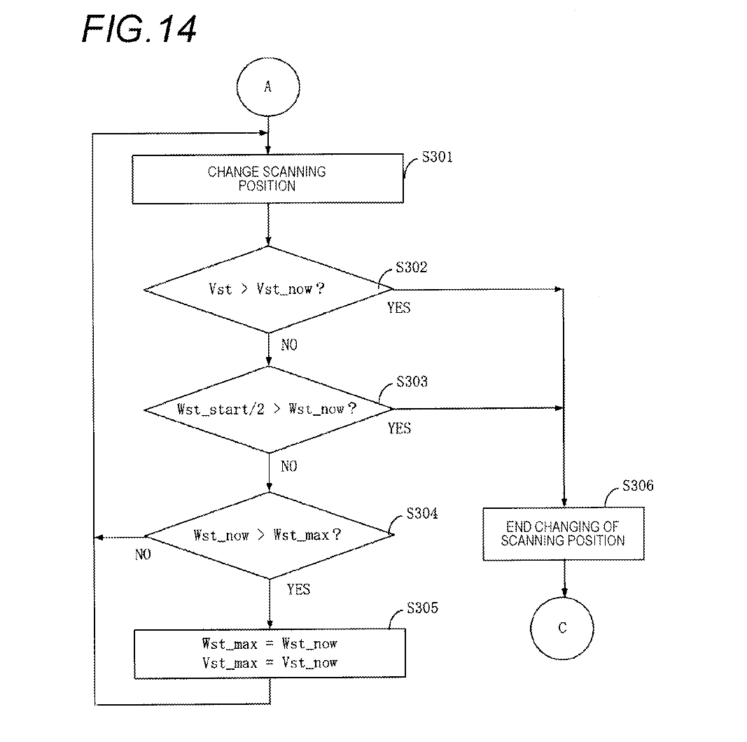

When the scanning end voltage Vst is equal to or less than the output voltage Vst_start of the PV panel 10 at the time of starting the scanning process, the process flow goes to the process shown in FIG. 14. The control unit 26 changes the operating voltage in the scanning process from Vst_strat to a lower side (toward a lower voltage) and observes the PV characteristic.

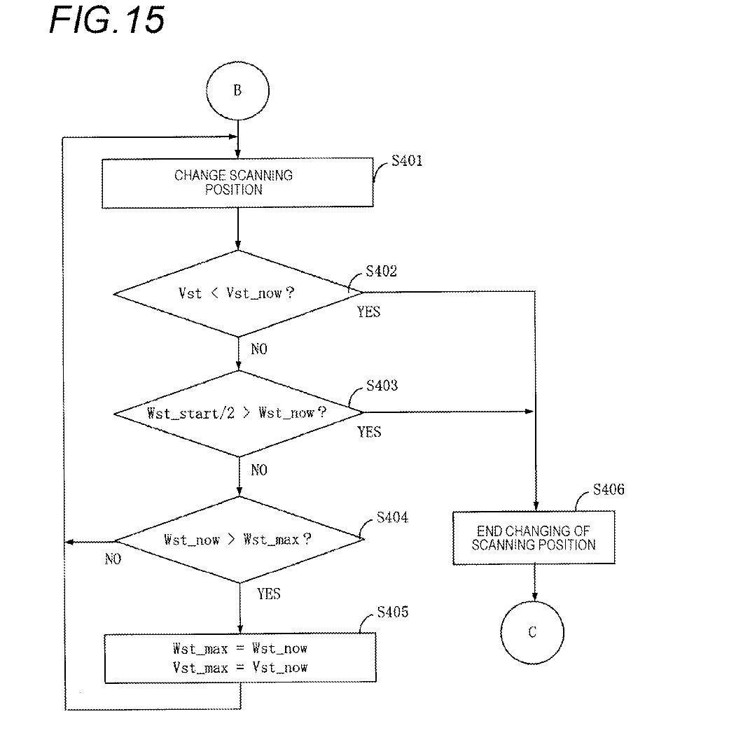

On the other hand, when the scanning end voltage Vst is larger than the output voltage Vst_start of the PV panel 10 at the time of starting the scanning process, the process flow goes to the steps shown in FIG. 15. The control unit 26 changes the operating voltage in the scanning process from Vst_strat to a higher side (toward a higher voltage) and observes the PV characteristic.

In this way, on the basis of the magnitude relationship between the scanning end voltage Vst and the output voltage Vst_start of the PV panel 10 at the time of starting the scanning process, it is possible to change the scanning position in a direction in which there is a possibility that another local maximum power point is present even when the voltage position at which the scanning process is started is high or low.

For example, the PV characteristics shown in FIGS. 6 to 9 are obtained through the scanning process shown in FIG. 14 or 15.

In FIG. 14, when the scanning end voltage Vst is equal to or less than Vst_start, the control unit 26 changes the scanning position (operating voltage) to a side lower by one step (S301). The operating voltage is changed by a voltage range of a predetermined step size. The control unit 26 sets the changed operating voltage as the current operating voltage Vst_now.

Subsequently, the control unit 26 determines whether the scanning end voltage Vst is larger than the current operating voltage Vst_now (S302).

When the scanning end voltage Vst is larger than the current operating voltage Vst_now, the end point of the voltage range determined in the process shown in FIG. 12 is reached and thus the changing of the scanning position ends (S306).

When the scanning end voltage Vst is equal to or less than the current operating voltage Vst_now, the control unit 26 determines whether a first predetermined value (for example, a half of Vst_start) is larger than Vst_now (S303).

In the process of step S303, it is determined whether the current operating voltage Vst_now is excessively lower than the output voltage Vst_start of the PV panel 10 at the time of starting the scanning process. When the predetermined value is larger than the current operating voltage Vst_now, it means that the current operating voltage is excessively lower and a possibility that the local maximum power points are present is low, thereby ending the changing of the scanning position (S306). Accordingly, the changing range of the operating voltage in the scanning process is narrowed and it is thus possible to reduce the scanning process time. It is possible to keep detection accuracy of the maximum power point high.

The predetermined value may not be a half of Vst_start and may have only to be set so that the scanning process does not end between a local maximum power point and another local maximum power point.

When the predetermined value is equal to or less than the current operating voltage Vst_now, the control unit 26 determines whether the power Wst_now at the current operating voltage is larger than the maximum power of the PV panel 10 in the scanning process stored in the register Wst_max (S304).

When the power Wst_now at the current operating voltage is equal to or less than the value of the register Wst_max, there is no possibility that the power Wst_now at the current operating voltage is the maximum power point. Therefore, the MPPT slave device 20 does not particularly store Wst_now and Vst_now.

After performing the process of step S304, the process flow returns to step S301 and the control unit 26 changes the scanning position to a next scanning position in step S301.

When the power Wst_now at the current operating voltage is larger than the value of the register Wst_max, the control unit 26 stores the power Wst_now at the current operating voltage in the register Wst_max (S305). In this case, the control unit 26 stores the current operating voltage Vst_now in the register Vst_max (S305). Accordingly, it is possible to retain information on the power and the voltage at which the presence of the maximum power point is possible.

After performing the process of step S305, the process flow returns to step S301 and the control unit 26 changes the scanning position to a next scanning position.

In FIG. 15, when the scanning end voltage Vst is equal to or less than Vst_start, the control unit 26 changes the scanning position (operating voltage) to a side higher by one step (S401). The operating voltage is changed by a predetermined voltage range. The control unit 26 sets the changed operating voltage as the current operating voltage Vst_now.

Subsequently, the control unit 26 determines whether the scanning end voltage Vst is smaller than the current operating voltage Vst_now (S402).

When the scanning end voltage Vst is smaller than the current operating voltage Vst_now, the end point of the voltage range determined in the process shown in FIG. 12 is reached and thus the changing of the scanning position ends (S406).

When the scanning end voltage Vst is equal to or more than the current operating voltage Vst_now, the control unit 26 determines whether a first predetermined value (for example, a half of Vst_start) is larger than Vst_now (S403).

In the process of step S403, it is determined whether the current operating voltage Vst_now is excessively lower than the output voltage Vst_start of the PV panel 10 at the time of starting the scanning process. When the predetermined value is larger than the current operating voltage Vst_now, it means that the current operating voltage is excessively lower and a possibility that the local maximum power points are present is low, thereby ending the changing of the scanning position (S406). Accordingly, the changing range of the operating voltage in the scanning process is narrowed and it is thus possible to reduce the scanning process time. It is possible to keep detection accuracy of the maximum power point high.

The predetermined value may not be a half of Vst_start and may have only to be set so that the scanning process does not end between a local maximum power point and another local maximum power point.

When the predetermined value is equal to or less than the current operating voltage Vst_now, the control unit 26 determines whether the power Wst_now at the current operating voltage is larger than the maximum power of the PV panel 10 in the scanning process stored in the register Wst_max (S404).

When the power Wst_now at the current operating voltage is equal to or less than the value of the register Wst_max, there is no possibility that the power Wst_now at the current operating voltage is the maximum power point. Therefore, Wst_now and Vst_now are not particularly retained.

After performing the process of step S404, the process flow returns to step S401 and the control unit 26 changes the scanning position to a next scanning position in step S301.

When the power Wst_now at the current operating voltage is larger than the value of the register Wst_max, the control unit 26 stores the power Wst_now at the current operating voltage in the register Wst_max (S405). In this case, the control unit 26 stores the current operating voltage Vst_now in the register Vst_max (S405). Accordingly, it is possible to retain information on the power and the voltage at which the presence of the maximum power point is possible.

After performing the process of step S405, the process flow returns to step S401 and the control unit 26 changes the scanning position to a next scanning position.

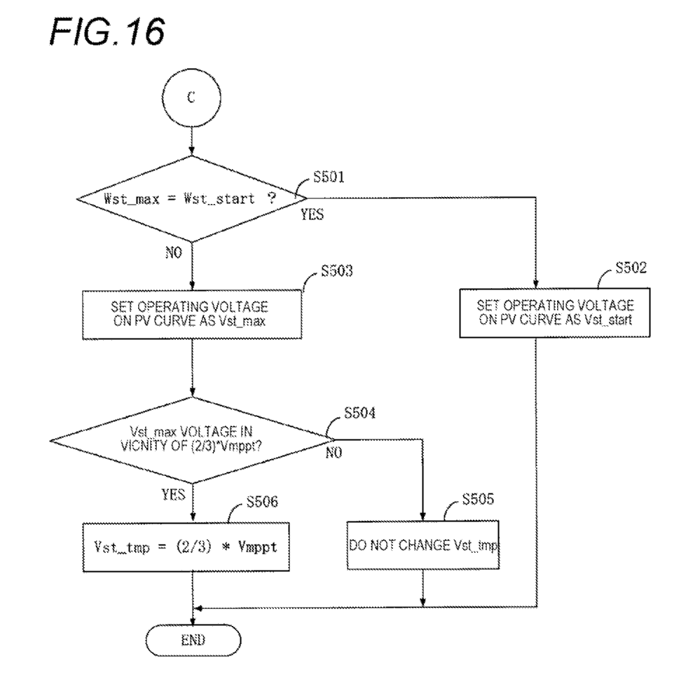

When the changing of the scanning position ends in step S306 of FIG. 14 or in step S406 of FIG. 15, the process flow goes to FIG. 16. The control unit 26 determines whether the value of the register Wst_max is approximately equal to the output power Wst_start of the PV panel 10 at the time of starting the scanning process (S501).

When the value of the register Wst_max is approximately equal to the output power Wst_start of the PV panel 10 at the time of starting the scanning process, the control unit 26 sets the output voltage Vst_start of the PV panel 10 at the time of starting the scanning process as the operating voltage in the PV characteristic (S502).

The process of step S502 means that the power at the time of starting the scanning process is the highest and the power is not exceeded until the scanning process ends. Therefore, the voltage of the maximum power point can be determined, for example, to be a voltage in the vicinity of the voltage Vmppt of the maximum power point under setting through the MPPT control. When the MPPT control is performed before the scanning process, the maximum power point determined through the MPPT control can be determined to be suitable. Even when other local maximum power points are present, the maximum power point previously determined through the MPPT control is larger than the local maximum power points.

When the value of the register Wst_max is not approximately equal to the output power Wst_start of the PV panel 10 at the lime of starting the scanning process, the control unit 26 sets the operating voltage in the PV characteristic as the value of the register Vst_max (S503). That is, the operating voltage in the PV characteristic is set to the voltage at which the maximum power of the PV panel 10 in the scanning process is output.

The process of step S503 means an operating voltage more than the voltage at the time of starting the scanning process is present until the scanning process ends. That is, it means that a local maximum power point larger than the power estimated as the maximum power point under setting through the MPPT control is present.

The operating voltage which is the maximum in the voltage range of the scanning process may not be the voltage of the maximum power point, but is included in the area (for example, a mountain area of a PV curve shape) of the operating voltage including the maximum power point. The MPPT slave device 20 can suitably reach the maximum power point by starting the MPPT control on the basis of the maximum output voltage of the PV panel 10 acquired through the scanning process.

By setting the maximum output voltage of the PV panel 10 as the operation start voltage in the next scanning process, it is possible to reduce the time which it takes to perform the next scanning process. For example, when the position of the shadow does not greatly vary, it can be considered that the PV characteristic does not greatly vary. In this case, the scanning process can rapidly end through the process of step S205 of FIG. 13.

Subsequently, the control unit 26 determines whether the value of the register Vst_max is about 2/3 of the voltage Vmppt of the maximum power point under setting (S504). About 2/3 is a value as a consideration result of a slight margin and is an example of the third predetermined value.

When the number of bypass diodes BD is three, three local maximum power points appear at a maximum. Specifically, the three local maximum power points include three points of a voltage which is about 1/3 of the voltage Vmppt of the maximum power point under setting, a voltage which is about 2/3 of the voltage Vmppt, and a voltage in the vicinity of the voltage Vmppt or the open voltage Vop. Among these, it is known that the possibility that the voltage which is about 1/3 of Vmppt is the maximum power is low. The possibility that the voltage which is about 2/3 of Vmppt or the voltage in the vicinity of Vmppt or the open voltage Vop is the maximum power point is high.

When the number of bypass diodes BD is two, two local maximum power points appear at a maximum. Specifically, the two local maximum power points include two points of a voltage which is about 1/2 of the voltage Vmppt of the maximum power point under setting and a voltage in the vicinity of the voltage Vmppt or the open voltage Vop.

When the value of the register Vst_max is a value which is about 2/3 of the voltage Vmppt of the maximum power point under setting, the control unit 26 changes the learning voltage Vst_tmp to the value of 2/3 of the voltage Vmppt of the maximum power point under setting (S506). In this case, the control unit 26 can determine that the number of bypass diodes BD is three. It is possible to set a scanning end voltage Vst suitable for the three bypass diodes BD.

When the value of the register Vst_max is not a value which is about 2/3 of the voltage Vmppt of the maximum power point under setting, the control unit 26 does not change the learning voltage Vst_tnip (S505). In this case, the control unit 26 can determine that the number of bypass diodes BD is two.

According to the scanning process in the MPPT slave device 20, it is possible to perform the scanning process in the voltage range of from a predetermined voltage (for example, the voltage Vmppt of the maximum power point under setting) to the scanning end voltage Vst and to acquire the PV characteristic of the PV panel 10.

This scanning process is properly repeatedly performed. That is, the control unit 26 performs a first scanning process in a first voltage range. The control unit 26 estimates a local maximum power point in the PV characteristic acquired through the scanning process. The control unit 26 performs a second scanning process in a second voltage range narrower than the first voltage range on the basis of the voltage position of the estimated local maximum power point.

By repeatedly performing the scanning process, it is possible to narrow the voltage position of the local maximum power point and thus to narrow the voltage range in which the scanning process is performed. Therefore, it is possible to reduce the processing time which it takes to perform the scanning process. Since the voltage range can be narrowed, it is possible to reduce a variation in output of the PV panel 10 under the scanning process. Therefore, it is possible to suppress an influence on, for example, electrical appliances connected to the photovoltaic power generation system 100 requiring constant power.

The scanning process may be performed at the same time as performing the process of determining the scanning end voltage Vst, instead of the time at which the scanning process start instruction is notified from the MPPT master device 30. For example, the scanning process may be performed at the time of starting up the MPPT slave device 20 or at the time at which there is a possibility that the PV characteristic of the PV panel 10 varies.

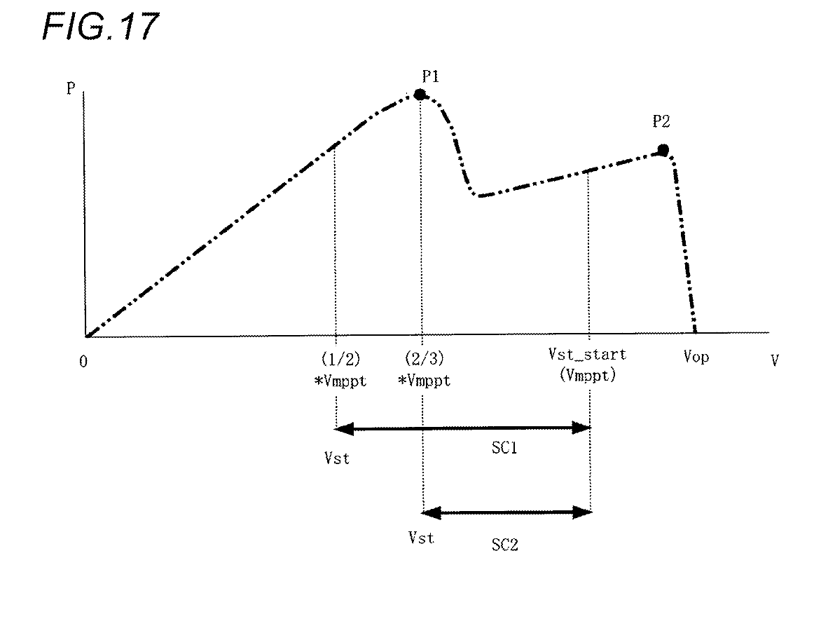

FIG. 17 is a diagram illustrating an example of voltages in the scanning process and the voltage range of the scanning process. For example, it is assumed that a first scanning process SC1 is started from the same output voltage Vst_start of the PV panel 10 at the time of starting the scanning process as the voltage Vmppt of the maximum power point under setting. In the first scanning process, since the MPPT slave device 20 does not know the number of bypass diodes BD, Vmppt/2 is set as the scanning end voltage Vst and the scanning process SC1 is performed.

When the first scanning process SC1 ends, the MPPT slave device 20 sets the scanning end voltage Vst to the voltage position of (2/3)×Vmppt. For example, it is assumed that a voltage position at which a second scanning process SC2 is started is set to the same Vst_start as in the first scanning process SC1. In this case, in the second scanning process SC2, the second scanning process is performed from Vst_start to (2/3)×Vmppt as the scanning end voltage Vst.

When the MPPT control is performed using Vst_start as a start point, the second highest local maximum power point P2 is searched for. However, by performing the scanning process, the highest local maximum power point P1 can be searched for and can be searched for as the maximum power point. Therefore, even when plural local maximum power points P1 and P2 are present, it is possible to estimate the highest local maximum power point P1 for a short time.

In FIG. 17, the PV characteristic when the scanning process is performed in the entire voltage range is shown for the purpose of explanation. Actually, only the PV characteristic between Vst_start and (1/2)×Vmppt is acquired in the first scanning process SC1. Only the PV characteristic between Vst_start and (2/3)×Vmppt is acquired in the second scanning process SC2.

The present invention is not limited to the configuration of the first embodiment, and any configuration may be employed as long as it can achieve the functions described in the appended claims or the functions of the configuration of the first embodiment.

It is assumed in the first embodiment that three or two bypass diodes BD are disposed, but four or more bypass diodes may be disposed. When four or more bypass diodes are disposed, parameters to be used are changed in the process of determining the scanning end voltage Vst and the scanning process.

A supplemental explanation of the first embodiment is explained.

In the step S105 of FIG. 12, the MPPT master device 30 may notify the second MPPT slave device 20 of a predetermined learning voltage Vst_tmp used by the first MPPT slave device 20. The PV panes 10 which constitute the photovoltaic power generation system 100 generally operate in a common model. In this case, the open voltage Vop and the learning voltage Vst_tmp determined based on the number of bypass diodes BD can be commonly used. In this way, since the second MPPT slave device 20 does not need to acquire the open voltage Vop in step S104, the scanning process is efficiently performed. Further, since the second MPPT slave device 20 identifies the number of bypass diodes BD of the PV panels 10 which are connected to the own device, the scanning process can be performed in an appropriate voltage range (the second scanning process SC2) from the beginning without performing the first scanning process SC1 as explained in FIG. 17.

Although the appropriate voltage range for the scanning process is obtained fully automatically by estimating the number of bypass diodes BD with the first scanning process SC1 as shown in FIG. 17, the appropriate voltage range may be obtained by any other methods. For example, the information of the PV panel 10 to be connected to the MPPT slave device 20 may be previously set in the MPPT slave device 20 before being attached to the PV panel 10. Alternatively, the MPPT slave device may be provided with an external switch (not illustrated in the drawings) so that the number (two, three or four) of bypass diodes BD is set with the external switch. Alternatively, the voltage range for the scanning process may be set in the MPPT slave device 20 through the MPPT master device 30 by remote access from another place.

In this way, the MPPT slave device 20 can change its voltage range for the scanning process in accordance with the PV panels connected thereto. Thus, the MPPT slave device 20 performs the scanning process in an appropriate voltage range in response to the characteristic of PV panels (e.g., the number of bypass diodes BD of the PV panels) connected thereto. Since the output voltage of the PV panel 10 is not changed to an unnecessary value, it is possible to suppress the degradation of power generation efficiency in the scanning process.

In the step S201 of FIG. 13, the MPPT slave device 20 may start the scanning process without receiving a scan request from the MPPT master device 30. For example, the scanning process may be performed regularly.

As performed in the step S201 of FIG. 13, in a case where the MPPT master device 30 controls a timing for performing the scanning process, it is preferable that the MPPT master device 30 does not cause a plurality of MPPT slave devices which are connected to the same PV string to simultaneously perform the scanning process. In other words, it should be controlled that, during one MPPT slave device 20 is performing the scanning process, the MPPT master device 30 does not send an instruction for the scanning process to another MPPT slave device 20 which is connected to the PV string to which the one MPPT slave device 20 is connected. If plural MPPT slave device 20 perform the scanning process simultaneously, it is possible that the voltage applied to the PV string is lowered. If the voltage of the PV string is lowered in comparison with that of another PV string, it is possible that a defect arises in MPPT control of the power conditioner 50. The defect can be suppressed by preventing plural MPPT slave devices from simultaneously performing the scanning process.

The scanning process as explained in the first embodiment may be applied in the power conditioner 50. In addition, it may be applied to an MPPT slave device which includes a DC-AC unit for converting a direct current of the PV panel 10 into an alternate current instead of having the DC-DC unit 25.

### Second Embodiment

First, a background of a second embodiment is explained.

A photovoltaic power generation system includes plural PV panels, plural MPPT units connected to the PV panels, respectively, and a power conditioner. Each MPPT unit can perform MPPT control so as to maximize the amount of power generated from the PV panel connected thereto. The power conditioner can perform MPPT control so as to maximize the total amount of power generated from all the plural PV panels.

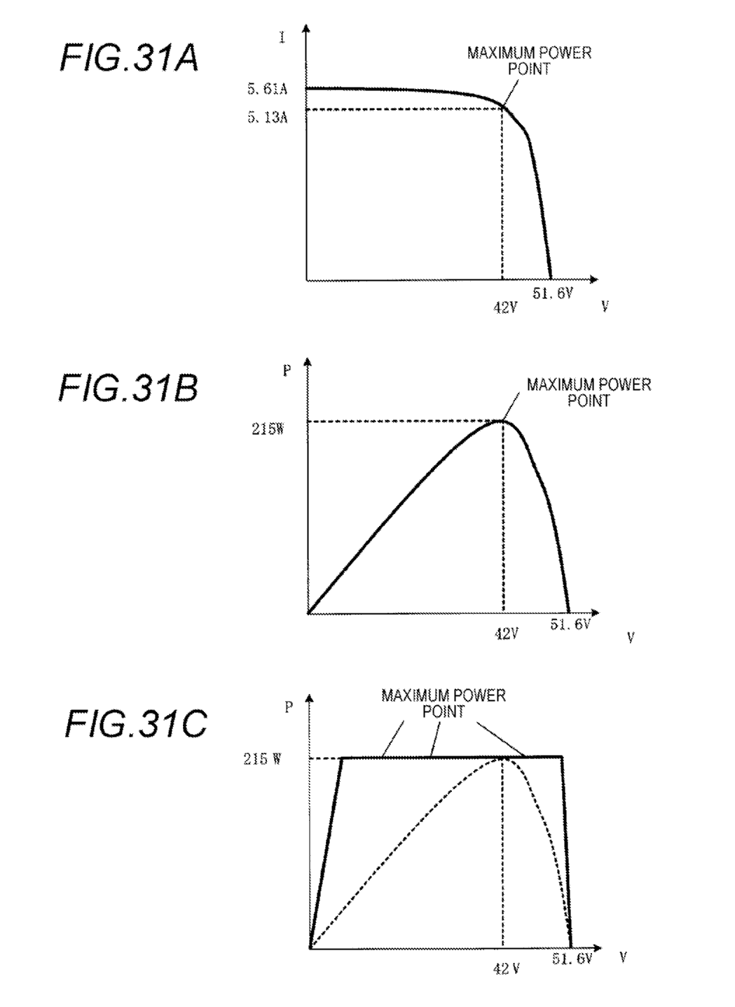

FIG. 31A is a diagram illustrating an IV (Current-Voltage) characteristic of a PV panel when an MPPT unit does not perform the MPPT control. FIG. 31B is a diagram illustrating a PV (Power-Voltage) characteristic of a PV panel when an MPPT unit does not perform the MPPT control. As shown in FIGS. 31A and 31B, when the MPPT control is not performed, a single maximum power point is determined.

FIG. 31C is a diagram illustrating an ideal PV characteristic of a PV panel when an MPPT unit performs the MPPT control. As shown in FIG. 31C, plural maximum power points are acquired at voltages in a predetermined range through the MPPT control.

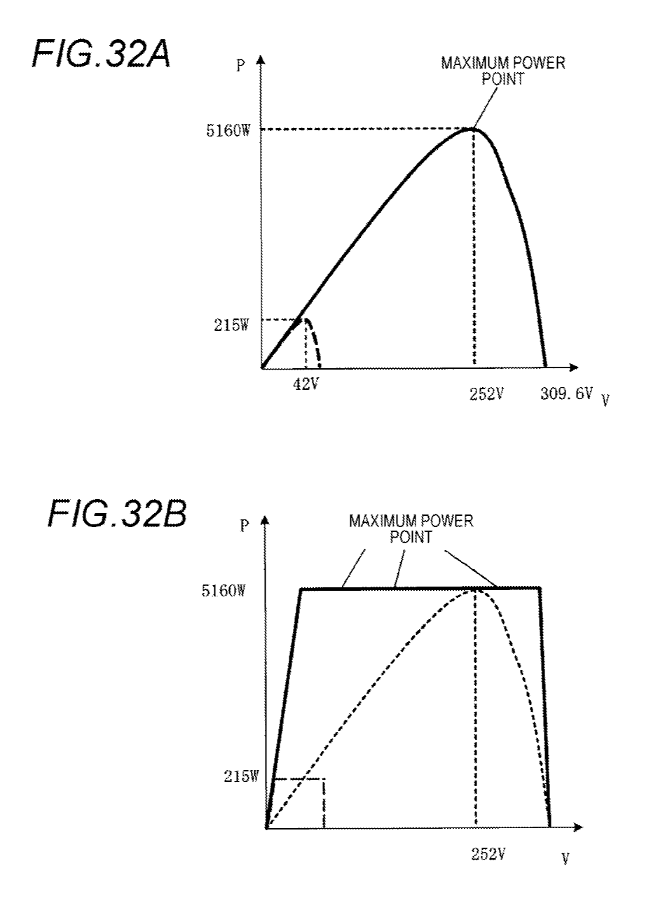

FIG. 32A is a diagram illustrating a PV characteristic of a PV panel when the PV panel is seen from the power conditioner where the power conditioner does not perform the MPPT control. FIG. 32B is a diagram illustrating an ideal PV characteristic of a PV panel when the PV panel is seen from the power conditioner where the power conditioner performs the MPPT control. As shown in FIGS. 32A and 32B, the voltage V is integrated by the number of PV panels connected in series and the power P is integrated by the number of PV panels connected in series or in parallel.

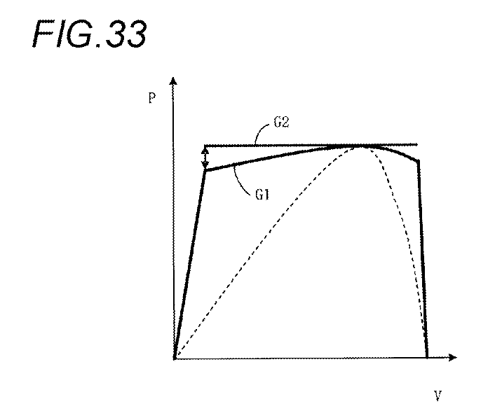

In the MPPT control in the MPPT unit, as shown in FIG. 32B, it is ideal to perform a control so as to make the generated power constant. However, actually, a conversion loss of several % is caused for each MPPT unit in consideration of the conversion efficiency of the DC-DC converter of the corresponding MPPT unit. The conversion loss is integrated in the power conditioner and a characteristic G1 including an error as shown in FIG. 33 is obtained.

In many cases, the power conditioner does not detect a fine voltage difference so as not to frequently change the output voltages of the PV panels through the MPPT control. In this case, the power conditioner cannot recognize the conversion loss of several % of the DC-DC converter of each MPPT unit. That is, the power conditioner recognizes a characteristic G2 as shown in FIG. 33. Therefore, the conventional power conditioner cannot track the maximum power point in the MPPT control and may perform MPPT control with low efficiency.

Hereinafter, a photovoltaic power generation system, a power control device, a control device, a power generation control method, and a control method which can improve power generation efficiency of each PV panel will be described.

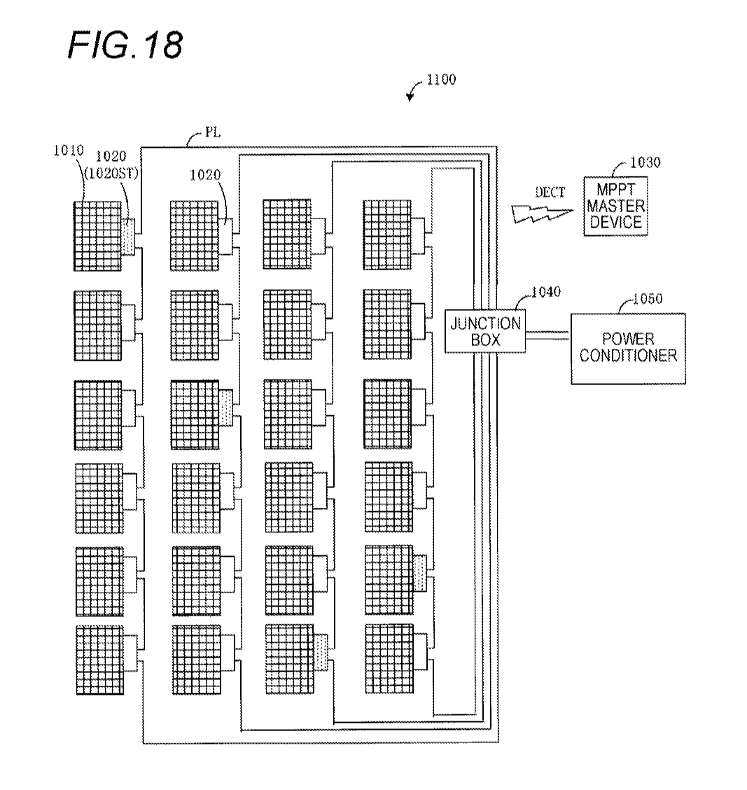

FIG. 18 is a diagram illustrating a configuration example of a photovoltaic power generation system 1100 according to the second embodiment of the present invention. The photovoltaic power generation system 1100 includes photovoltaic (PV) panels 1010, MPPT slave devices 1020, an MPPT master device 1030, a junction box 1040, and a power conditioner 1050. Each MPPT slave device 1020 is an example of the power generation control device. The MPPT master device 1030 is an example of the control device.

A PV panel 1010 is a panel including photovoltaic cells that converts optical energy into electric power using a photoelectric conversion effect. The PV panel 1010 may be a single photovoltaic cell or a photovoltaic cell module in which plural photovoltaic cells are combined. The PV panels 1010 are connected in series or in parallel to power lines PL. The PV panels 1010 are associated with the MPPT slave devices 1020 in a one-to-one manner.

In the example shown in FIG. 18, the PV panels 1010 are connected in series by a power line PL to constitute a photovoltaic string (PV string). The photovoltaic strings are connected in parallel to the junction box 1040 by the power lines PL to constitute a photovoltaic array (PV array). Six PV panels 1010 are connected in series to constitute a PV string, and four PV strings are connected in parallel to constitute a PV array. The number of PV panels and the number of PV strings are not limited to this example.

Each MPPT slave device 1020 controls power generated in the PV panel 1010 connected thereto. That is, the MPPT slave device 1020 receives the power generated in the PV panel 1010 connected thereto and controls the generated power to be a desired power. The desired power may vary by the MPPT slave devices 1020, for example, depending on the directions of the PV panels 1010, the installation location of the PV panels 1010, or the sunshine conditions.

For example, each MPPT slave device 1020 performs MPPT control on the PV panel 1010 connected thereto. The MPPT control of the MPPT slave device 1020 is a control for maximizing the amount of power generated in the PV panel connected thereto. The MPPT control can be realized using a known method and, for example, a hill-climbing method can be employed.

Further, the MPPT slave device 1020 controls the power generation power of the PV panel 1010, for example, on the basis of the power generation control information transmitted from the MPPT master device 1030. A method for the control will be described later.

The MPPT slave device 1020 serves as a slave unit of the MPPT master device 1030. A particular MPPT slave device 1020 among the MPPT slave devices 1020 operates as a string master 1020ST as described later.

The MPPT master device 1030 serves as a master unit of plural MPPT slave devices 1020. For example, the MPPT master device 1030 receives values (for example, a measured value of current, voltage, or power) measured by the MPPT slave devices 1020 from the MPPT slave devices 1020 and normally monitors the amounts of power generated in the PV panels 1010.

The installation place of the MPPT master device 1030 is not particularly limited. For example, the MPPT master device 1030 may be installed as an independent device in a place in which it can communicate with the MPPT slave devices 1020, may be installed in the power conditioner 1050, or may be installed in the junction box 1040. In FIG. 18, the MPPT master device 1030 is installed as an independent device.

The junction box 1040 collectively concentrates the power lines PL as wires in the unit of PV strings in which plural PV panels 1010 are connected in series and connects the power lines PL to the power conditioner 1050. The junction box 1040 includes, for example, terminals for connection to the power lines PL, switches used for check or maintenance, a lightning arrestor element, and a backflow preventing diode for preventing a backflow of electricity.

The junction box 1040 may be integrated with the power conditioner 1050. The junction box 1040 may be omitted.

The power conditioner 1050 converts DC power output from the junction box 1040 (DC-DC conversion) and converts the DC power into AC power again (DC-AC conversion). The power conditioner 1050 is connected to, for example, a power distribution board (not illustrated in the drawing).

The power conditioner 1050 performs MPPT control on the power input from the power conditioner 1050 in the DC-DC conversion. The MPPT control of the power conditioner 1050 is a control for maximizing the total amount of power generated from the PV panels 1010 included in the photovoltaic power generation system 1100. The MPPT control can be realized using a known method and, for example, a hill-climbing method can be employed.

The configuration example of an MPPT slave device 1020 will be described below.

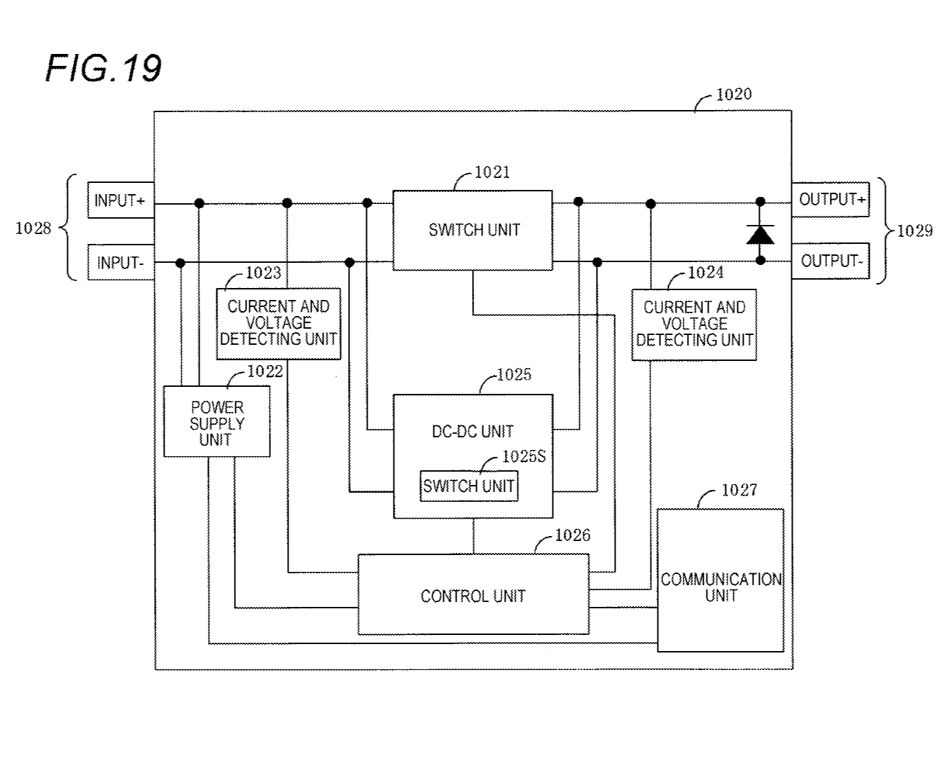

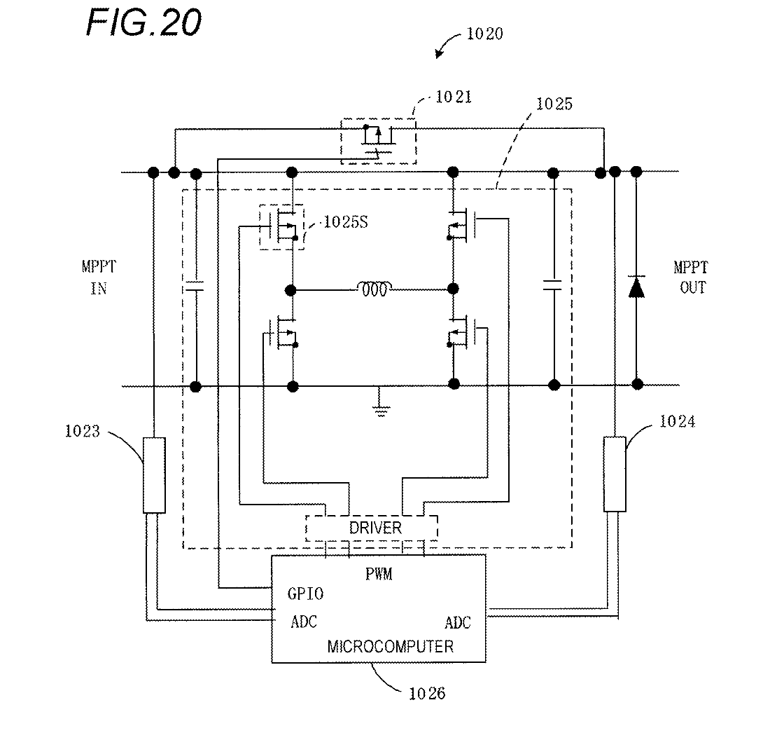

FIG. 19 is a diagram illustrating the configuration example of an MPPT slave device 1020. FIG. 20 is a diagram partially illustrating the detailed configuration example of the MPPT slave device 1020. The MPPT slave device 1020 includes a switch unit 1021, a power supply unit 1022, current and voltage detecting units 1023 and 1024, a DC-DC unit 1025, a control unit 1026, a communication unit 1027, an input terminal 1028, and an output terminal 1029.

The switch unit 1021 electrically connects or disconnects the input terminal 1028 and the output terminal 1029 of the MPPT slave device 1020 to and from each other. The ON and OFF states of the switch unit 1021 are controlled in response to a switching signal from the control unit 1026.

When the input terminal 1028 and the output terminal 1029 are electrically connected to each other (ON state), the power from the PV panel 1010 connected to the MPPT slave device 1020 is made to pass to the output terminal 1029 without any change. Accordingly, it is possible to monitor the output of the PV panel 1010.

When the input terminal 1028 and the output terminal 1029 are electrically disconnected from each other (OFF state), the power from the PV panel 1010 connected to the MPPT slave device 1020 is not output through the path passing through the switch unit 1021.

The power supply unit 1022 is supplied with power from the PV panel 1010 and supplies the power to the constituent units of the MPPT slave device 1020.

The current and voltage detecting unit 1023 detects an output current and an output voltage of the PV panel 1010. That is, the current and voltage detecting unit 1023 detects the current value and the voltage value before the DC-DC unit 1025 converts the voltage. The current detected by the current and voltage detecting unit 1023 is also referred to as input-side detected current and the voltage detected by the current and voltage detecting unit 1023 is also referred to as input-side detected voltage.

The current and voltage detecting unit 1024 detects an output current and an output voltage of the switch unit 1021 or the DC-DC unit 1025. That is, the current and voltage detecting unit 1024 detects the current value and the voltage value passing through the switch unit 1021 or the current value and the voltage value after the DC-DC unit 1025 converts the voltage. The current detected by the current and voltage detecting unit 1024 is also referred to as output-side detected current and the voltage detected by the current and voltage detecting unit 1024 is also referred to as output-side detected voltage.

The DC-DC unit 1025 is a DC/DC converter and includes a switch unit 1025S having a power-conversion switching element. The switch unit 1025S controls the power supplied from the PV panel 1010 via the power line PL by appropriately switching the ON and OFF states thereof.

The DC-DC unit 1025 receives the output voltage of the PV panel 1010 and converts the input voltage using the switch unit 1025S. The DC-DC unit 1025 has a function of a voltage converting unit that converts the output voltage of the PV panel 1010. The ON and OFF states of the switch unit 1025S are controlled in response to a PWM (Pulse Width Modulation) signal from the control unit 1026.

When performing the MPPT control, the control unit 1026 determines a duty cycle (PWM value) indicating a ratio of the ON time and the OFF time of the switch unit 1025S of the DC-DC unit 1025 so as to maximize the output voltage of the photovoltaic panel 1010, and controls the ON and OFF states of the switch unit 1025S. In the MPPT control, the duty cycle is variable. The control unit 1026 has a function of a voltage conversion control unit that controls the duty cycle.

The control unit 1026 controls the DC-DC unit 1025 on the basis of power generation control information transmitted from an MPPT master device 1030. In this case, the control unit 1026 fixes the PWM value of the switch unit 1025S of the DC-DC unit 1025. In this case, the control unit 1026 controls the DC-DC unit 1025 to operate by fixing the PWM value to a value with which a specific output voltage is obtained with respect to a specific input voltage.

For example, when the power generation control information includes information on a voltage, the control unit 1026 calculates the PWM value from the information on a voltage and controls the ON and OFF states of the switch unit 1025S on the basis of the calculated PWM value. Accordingly, it is possible to reduce a processing load of the MPPT master device 1030. When the power generation control information includes information on the PWM value, the control unit 1026 controls the ON and OFF states of the switch unit 1025S on the basis of the PWM value. Accordingly, it is possible to reduce a processing load of the MPPT slave device 1020.

A communication unit 1027 communicates with another MPPT slave device, the MPPT master device 1030, or a power conditioner 1050 in a wired or wireless manner. Examples of this communication method include power line communication (PLC) using a power line, DECT (Digital Enhanced Cordless Telecommunication), or Zigbee (registered trademark).

For example, the communication unit 1027 transmits detection information including the values detected by current and voltage detecting units 1023 and 1024 to the MPPT master device 1030. The detection information includes, for example, the input-side detected current value and the input-side detected voltage value. The detection information may include the output-side detected current value and the output-side detected voltage value in addition to the input-side information.

For example, the communication unit 1027 receives power generation control information transmitted from the MPPT master device 1030. The power generation control information includes a desired value of an output-side voltage, an input-side voltage and an output-side voltage, or a PWM value (duty cycle). The power generation information may be other information allowing the above-mentioned, values to be calculated or may be information such as an input-side current and an output-side current.

The configuration example of the MPPT master device 1030 will be described below.

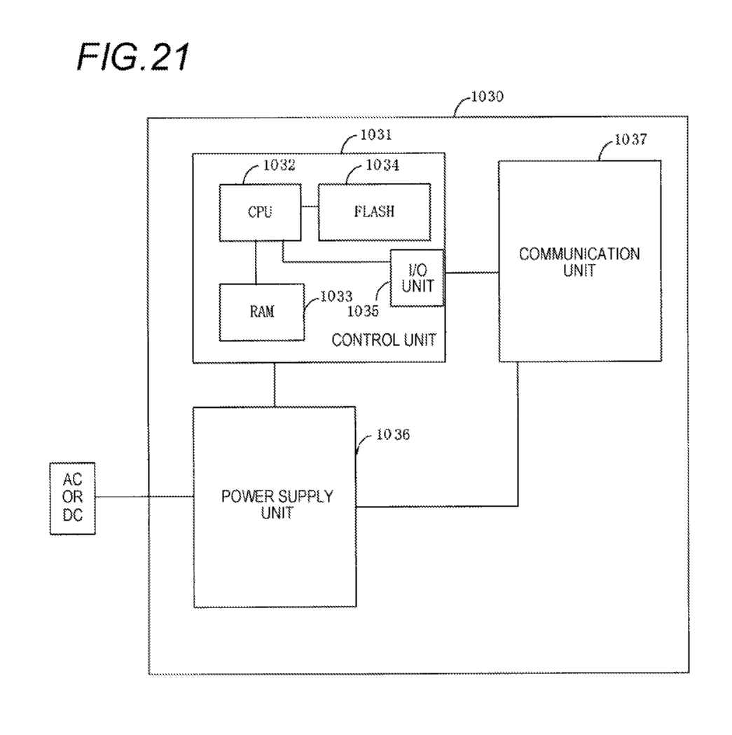

FIG. 21 is a diagram illustrating the configuration example of the MPPT master device 1030. The MPPT master device 1030 includes a control unit 1031, a power supply unit 1036, and a communication unit 1037. The control unit 1031 includes a CPU (Central Processing Unit) 1032, a RAM (Random Access Memory) 1033, a flash memory (Flash) 1034, and an I/O (Input/Output) unit 1035.

The control unit 1031 performs various processes, for example, by causing the CPU 1032 to execute a program stored in the RAM 1033. The processing result of the control unit 1031 is transmitted to another device, for example, via the I/O unit 1035 by the communication unit 1037. The I/O unit 1035 is a communication interface between the control unit 1031 and the communication unit 1037 and includes, for example, a UART (Universal Asynchronous Receiver Transmitter) or an I2C.

The control unit 1031 has a function of a master determining unit that determines an MPPT slave device 1020 in which the PWM value should be fixed as a master. A master is, 14 example, a string master 1020ST in which the PWM value in a predetermined string is fixed. The control unit 1031 has a function of a reference voltage determining unit that determines a reference voltage to be described later. The control unit 1031 has a function of an output voltage determining unit that determines an output voltage of the string master 1020ST. The control unit 1031 has a function of a duty cycle determining unit that determines the PWM value of the string master 1020ST.

The power supply unit 1036 is supplied with power, for example, from a commercial power supply (AC power supply or DC power supply) and supplies the power to the constituent units of the MPPT master device 1030.

The communication unit 1037 communicates with the MPPT slave devices 1020 in a wired or wireless manner. Examples of this communication method include power line communication (PLC) using a power line, DECT, or Zigbee (registered trademark).

For example, the communication unit 1037 receives detection information from the MPPT slave devices 1020 and transmits the power generation control information to the MPPT slave devices 1020.

The power conditioner 1050 includes, for example, a DC/DC converter, a control unit for performing MPPT control, a communication unit for communication with another device, and a DC/AC converter.

The operation example of the MPPT master device 1030 will be described below.

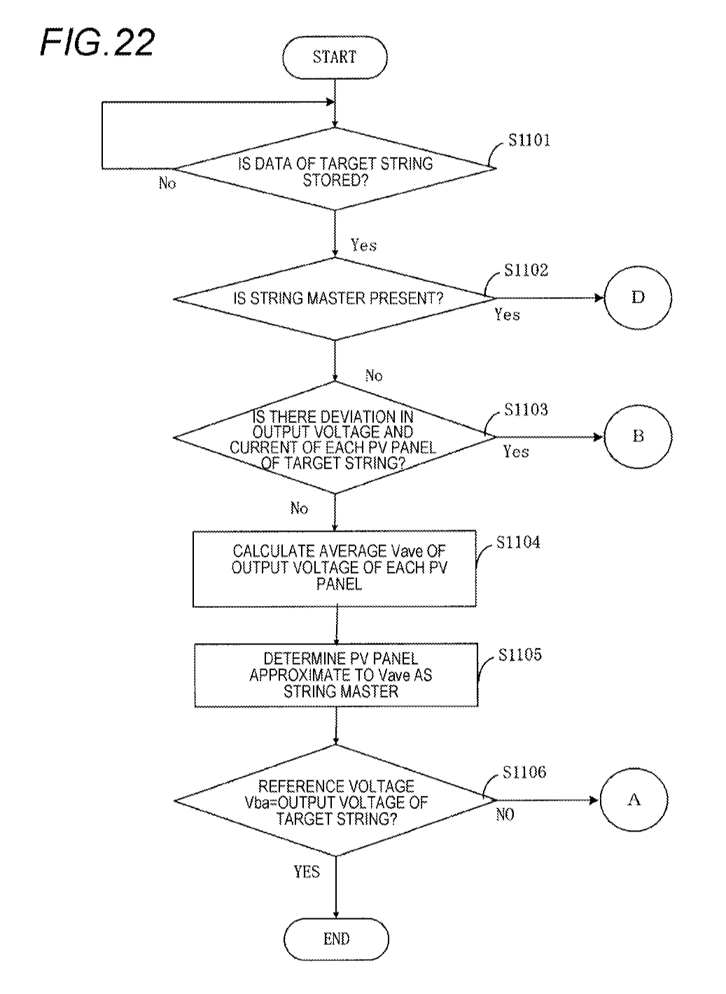

FIGS. 22 to 27 are flowcharts illustrating the operation example of the MPPT master device 1030. FIGS. 22 to 26 illustrate a flow of a process of determining a PWM value of a string master 1020ST and it is periodically performed, for example, every minute.

First, in FIG. 22, the control unit 1031 determines whether data of a string (target string) to be subjected to a process of determining a PWM value of a string master 1020ST is retained (S1101).

The control unit 1031 stores the detection information periodically transmitted from the MPPT slave devices 1020 in the RAM 1033 or the flash memory 1034. The detection information from an MPPT slave device 1020 is stored along with identification information (panel ID) of the PV panel 1010 connected to the MPPT slave device 1020 as a transmission source of the detection information and identification information (for example, string ID) of a string to which the PV panel 1010 belongs.

The control unit 1031 determines the order of target strings in advance or arbitrarily, and determines that data is retained when data of a string ID matched with the target string is stored.

Subsequently, the control unit 1031 determines whether the string master 1020ST in the target string is determined already (S1102). When the string master is determined already, the process flow goes to step S1141. When the string master is not determined already, the process flow goes to step S1103. In the initial state, the string master is “not determined”.

When the string master 1020ST is not determined already, the control unit 1031 determines whether the output voltages or the output currents of each PV panel 1010 included in the target string have a deviation (S1103). The output voltage and the output current of the PV panel 1010 correspond to the input-side detected voltage and the input-side detected current of the corresponding MPPT slave device 1020.

When a deviation is present, it means, for example, that a standard deviation of the output voltages or the output currents of plural PV panels 1010 included in the target string is equal to or more than a predetermined value. The standard deviation is an example of a difference in output of the PV panels 1010. When a deviation is present, the process flow goes to step S1121. When a deviation is not present, the process flow goes to step S1104.

When a deviation is not present in the output voltages or the output currents of the PV panels 1010, the control unit 1031 calculates an average value Vave of the output voltages of the PV panels 1010 (S1104). By using the average value Vave, the variation in voltage of all the PV panels 1010 is reduced and the time (convergence time) required from the start of change of a voltage to the end of change is reduced, when the output voltages of the PV panels 1010 are changed. The average value Vave is an example of a statistical value and, for example, a median value of plural output voltages may be used instead of the average value.

Subsequently, the control unit 1031 determines an MPPT slave device 1020 connected to the PV panel 1010 of which the output voltage is approximate to the average value Vave as a string master 1020ST (S1105). The approximate PV panel 1010 may be, for example, a PV panel 1010 that outputs the output voltage closet to the average value Vave or may be a PV panel 1010 of which the output voltage is within a predetermined range from the average value Vave. By determining a master for each string, it is possible to surely recognize the maximum operating point in the unit of string.

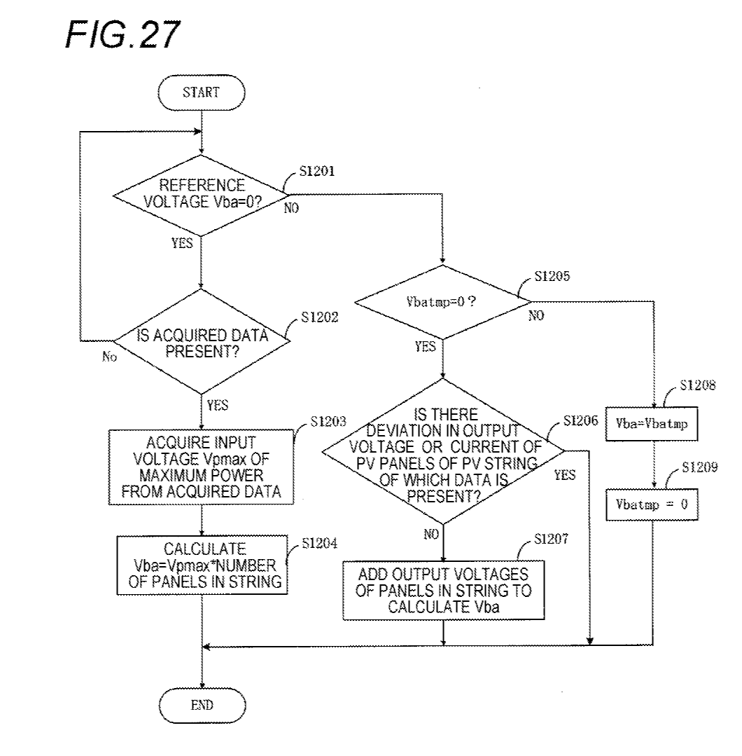

Subsequently, the control unit 1031 determines whether a reference voltage Vba and an output voltage of a target string are approximately equal to each other (S1106). The reference voltage Vba is the total sum of voltages to be output from the PV panels 1010 belonging to the PV string and is determined by the processes shown in FIG. 27 in the master in which the PWM value is fixed to be described later. The output voltage of the target string is the total sum of output voltages of the PV panels 1010 belonging to the target string.

When the reference voltage Vba and the output voltage of the target string are approximately equal to each other, the control unit 1031 ends the process of determining the PWM value of the string master 1020ST. In this case, the reference voltage Vba corresponds to the operating voltage at the maximum power points of the PV panels 1010 belonging to the target string, which is already in a desired state. Therefore, for example, determination of a string master and setting of a PWM value in an MPPT slave device 1020 may not be newly performed, and the PWM value is kept variable. Even when the PWM value is kept variable, the desired state can be continuously maintained.

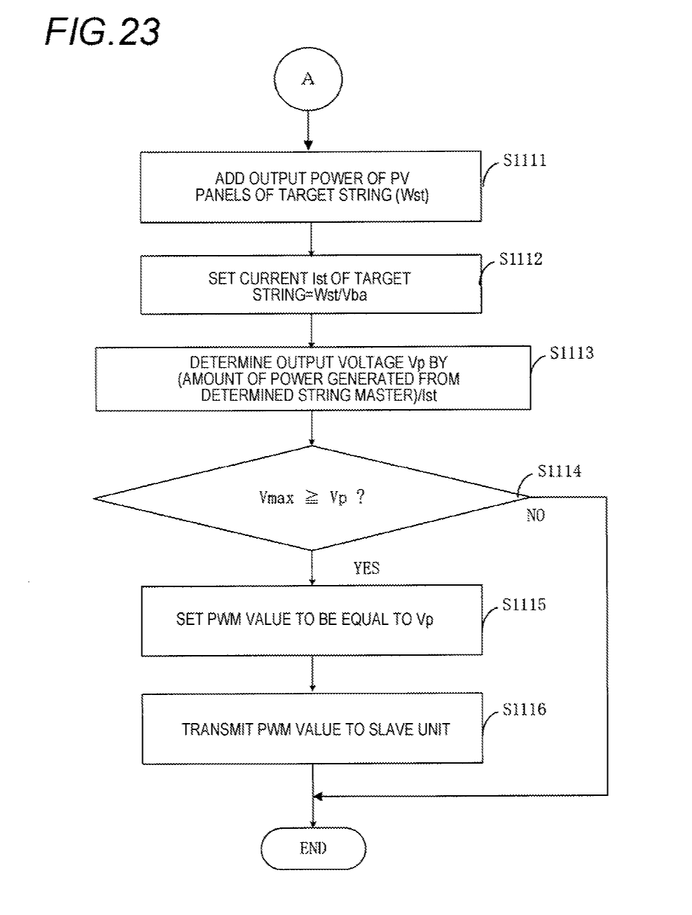

When the reference voltage Vba and the output voltage of the target string are not approximately equal to each other, the process flow goes to FIG. 23 and the control unit 1031 calculates the total sum Wst of the output power of the PV panels 1010 belonging to the target string (S1111). The output power of each PV panel 1010 is calculated, for example, by multiplying the output voltage of the PV and 1010 by the output current thereof.

Subsequently, the control unit 1031 calculates a desired string current Ist flowing in the target string (S1112). For example, the control unit 1031 divides the total sum Wst of the output power by the reference voltage Vba and sets the division result as the string current Ist.

Subsequently, the control unit 1031 determines a desired output voltage Vp of the string master 1020ST (S1113). For example, the control unit 1031 divides the amount of power (output power) generated in the PV panels 1010 connected to the string master 1020ST by the desired string current Ist and sets the division result as the desired output voltage Vp of the string master 1020ST. By using the desired output voltage Vp, it is possible to designate the output voltage of the string master 1020ST even when the reference voltage Vba and the output voltage of the target string are not equal to each other.

Subsequently, the control unit 1031 determines whether the maximum output voltage Vmax of the MPPT slave device 1020 is equal to or more than the desired output voltage Vp of the string master 1020ST (S1114). When Vmax is equal to or more than Vp, the process flow goes to step S1115. When Vmax is less than Vp, the control unit 1031 ends the process of determining the PWM value of the string master 1020ST.

When Vmax is equal to or more than Vp, the control unit 1031 determines the PWM value of the string master 1020ST so that the output-side detected voltage of the string master 1020ST is the desired output voltage Vp (S1115). The control unit 1031 determines the PWM value, for example, on the basis of the input-side detected voltage of the string master 1020ST included in the detection information and the desired output voltage Vp.

For example, the input-side detected voltage is defined as Vin. When the desired output voltage Vp is more than the input-side detected voltage Vin, the control unit 1031 controls the DC-De unit 1025 to raise the voltage. Specifically, the duty cycle D as the PWM value can be expressed by D=1−(Vin/Vp). On the other hand, when the desired output voltage Vp is less than the input-side detected voltage Vin, the control unit 1031 controls the DC-DC unit 1025 to lower the voltage. Specifically, the duty cycle D as the PWM value can be expressed by D=Vout/Vin.

Subsequently, the communication unit 1037 transmits the power generation control information including the PWM value of the string master 1020ST determined by the control unit 1031 to the string master 1020ST (S1116). Accordingly, the string master 1020ST can recognize the PWM value to be set and can set the PWM value to a fixed value.

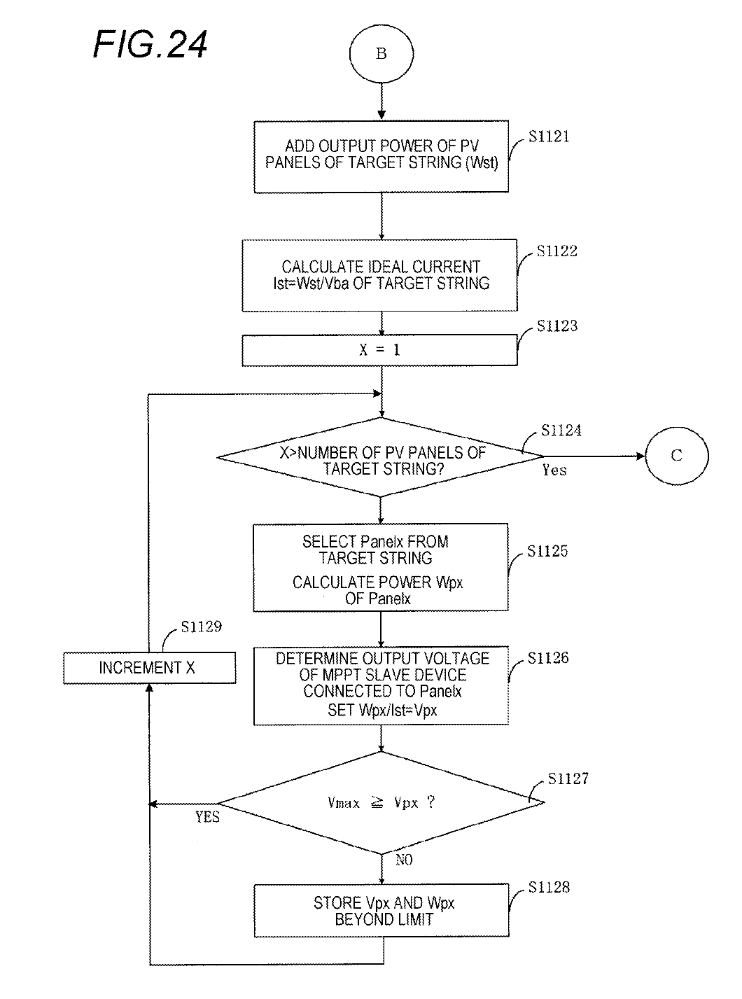

In step S1103, when the output voltage or the output current of the PV panels 1010 belonging to the target string is deviated, the process flow goes to the process shown in FIG. 24 and the control unit 1031 calculates the total sum Wst of the output power of the PV panels 1010 belonging to the target string (S1121).

Subsequently, the control unit 1031 calculates the desired string current Ist flowing in the target string (S1112). For example, the control unit 1031 divides the total sum Wst of the output power by the reference voltage Vba and sets the division result as the desired string current Ist.

Subsequently, the control unit 1031 sets variable X to 1 (S1123).

Subsequently, the control unit 1031 determines whether variable X is more than the number of PV panels 1010 belonging to the target string (S1124). When variable X is equal to or less than the number of PV panels, the process flow goes to step S1125. When variable X is more than the number of PV panels, the process flow goes to step S1131. That is, in step S1124, the control unit 1031 determines whether a predetermined process (steps S1125 to S1128) is completely performed on the PV panels 1010 belonging to the target string.

When variable X is equal to or less than the number of PV panels 1010, the control unit 1031 selects the PV panel 1010 (Panelx) corresponding to variable X from the target string and calculates the output power Wpx of Panelx (S1125). The MPPT master device 1030 retains the identification information (for example, panel ID) of the PV panels 1010. The control unit 1031 can correlate variable X with the panel ID in a one-to-one correspondence manner.

Subsequently, the control unit 1031 determines the desired output voltage Vpx of the MPPT slave device 1020 connected to Panelx (S1126). For example, the control unit 1031 divides the output current Wpx of Panelx by the desired string current Ist and sets the division result as the desired output voltage Vpx.

Subsequently, the control unit 1031 determines whether the maximum output voltage Vmax of the MPPT slave device 1020 is equal to or more than the desired output voltage Vpx of the MPPT slave device 1020 connected to Panelx (S1127).

When Vmax is less than Vpx, the control unit 1031 stores the desired output voltage Vpx of the MPPT slave device 1020 connected to Panelx and the output power Wpx of Panelx, for example, in the RAM 1033 or the flash memory 1034 (S1128). The stored Vpx and Wpx are also called Vpx and Wpx beyond a limit.

When Vmax is equal to or more than Vpx in step S1127 or when Vpx and Wpx are stored in step S1128, the control unit 31 increases variable X by 1 (S1129) and the process flow goes to step S1124.

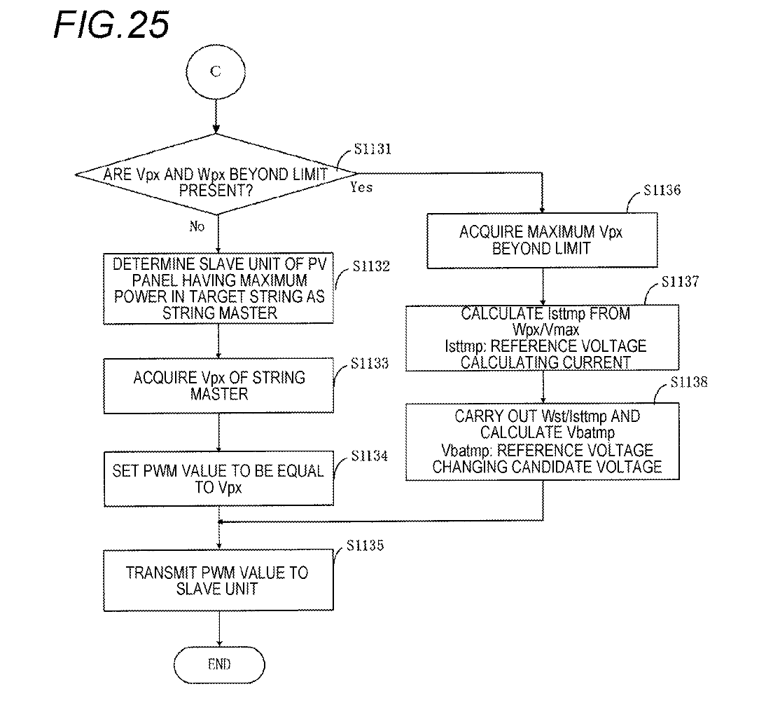

In step S1124, when variable X is more than the number of PV panels 1010 belonging to the target string, the process flow goes to the process of FIG. 25 and the control unit 1031 determines whether the desired output voltage Vpx of the MPPT slave device 1020 connected to Panelx and the output power Wpx of Panelx are stored (S1131). That is, the control unit 1031 determines whether Vpx and Wpx beyond a limit are stored.

When Vpx and Wpx beyond a limit are not stored, all the MPPT slave devices 1020 in the target string can output the desired output voltage Vpx of the MPPT slave device 1020 connected to the PV panel 1010 connected to the MPPT slave device 1020 using the set reference voltage Vba. In this case, the control unit 1031 determines the MPPT slave device 1020 connected to Panelx having the maximum output power Wpx in the target string as the string master 1020ST (S1132). In this way, even when the output voltage and the output current of the PV panels 1010 are deviated, it is possible to determine the string master 1020ST having the maximum output voltage in the target string.

Subsequently, the control unit 1031 acquires the desired output voltage Vp of the determined string master 1020ST (S1133).

Subsequently, the control unit 1031 determines the PWM value of the string master 1020ST so that the output-side detected voltage of the string master 1020ST is the desired output voltage Vp (S1134). The method of determining the PWM value is the same as the method of determining the PWM value in step S1115.

Subsequently, the communication unit 1037 transmits information on the PWM value of the string master 1020ST determined by the control unit 1031 to the string master 1020ST (S1135). Accordingly, even when the output voltage or the output current of the PV panels 1010 in the target string is deviated, it is possible to determine the string master 1020ST and to notify the PWM value thereof. Therefore, the string master 1020ST can recognize the PWM value to be set and set the PWM value to a fixed value.

When the desired output voltage Vpx of the MPPT slave device 1020 connected to Panelx and the output power Wpx of Panelx are stored in step S1131, the control unit 1031 acquires the maximum Vpx from the stored Vpx (S1136). The maximum Vpx is an example of the output voltage Vpx of the MPPT slave device 1020 connected to Panelx having a predetermined value or more.

When Vpx and Wpx beyond a limit are stored, it means that the target string includes Panelx which cannot output the desired output voltage Vpx using the set reference voltage Vba. Therefore, the control unit 1031 requests for necessary information so as to change the reference voltage Vba.

Subsequently, the control unit 1031 calculates a reference voltage-calculating current Isttmp (S1137). The control unit 1031 divides, for example, the maximum output voltage Vmax of the MPPT slave device 1020 by the acquired maximum Vpx and sets the division result as the reference voltage-calculating current Isttmp.

Subsequently, the control unit 1031 calculates a reference voltage change candidate voltage Vbatmp (S1138). The control unit 1031 divides, for example, the total sum Wst of the output power of the PV panels 1010 in the target string by the calculated reference voltage-calculating current Isttmp and sets the division result as the reference voltage change candidate voltage Vbatmp.

Wpx is described above to be the output power of Panelx, but may be the output power of the MPPT slave device 1020 connected to Panelx. The output power of Panelx and the output power of the MPPT slave device 1020 connected to Panelx are equal to each other.

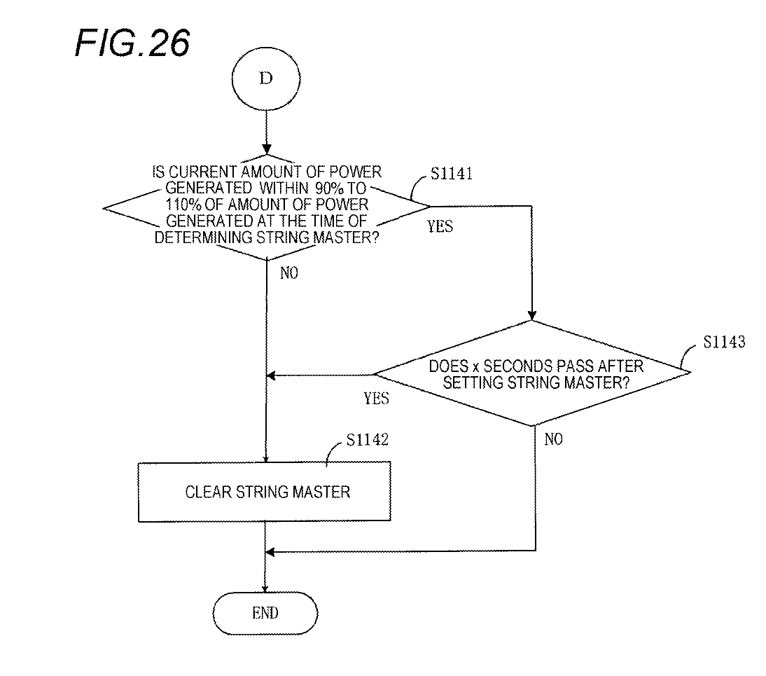

When the string master 1020ST is determined already in step S1102, the process flow goes to the process of FIG. 26. In this case, the control unit 1031 determines whether the amount of power generated in the PV panel 1010 connected to the current string master ST is within a predetermined reference range from the amount of power generated in the PV panel 1010 connected to the string master 1020ST at the time of determining the string master (S1141). “Within a predetermined reference range” means that the current amount of power generated is within a predetermined range (for example, 90% to 110%) of the amount of power generated at the time of determining the string master. The string master 1020ST stores information on the amount of power generated at the time of determining the string master, for example, in the Ram 1033 or the flash memory 1034.

When the amount of power generated is within a predetermined reference range, the control unit 1031 determines whether a predetermined time passes from the time of determining the string master 1020ST (S1142). The time of determining the string master 1020ST is, for example, a time point at which the processes shown in FIGS. 22 to 25 are performed.

When the amount of power generated in the PV panels 1010 connected to the string master 1020ST is not within a predetermined reference range in comparison with the amount of power generated at the time of determining the string master or when a predetermined time passes from the time of determining the string master, the control unit 1031 clears the string master 1020ST (S1143).

Accordingly, when the amount of power generated in the PV panels 1010 connected to the string master 1020ST varies, for example, due to a state variation of the PV panels 1010 or a weather variation, an inappropriate string master 1020ST can be cleared. Therefore, the string master 1020ST can be re-determined to obtain an appropriate amount of power generated in the target string.

The process of determining the reference voltage Vba will be described below.

FIG. 27 is a flowchart illustrating an example of the process of determining the reference voltage Vba. The initial value of the reference voltage Vba is “0”. The process shown in FIG. 27 is performed, for example periodically or when the reference voltage change candidate voltage Vbatmp is calculated in step S1138 of FIG. 25.

First, the control unit 1031 determines whether the reference voltage Vba is “0” (S1201). When the reference voltage Vba is “0”, the process flow goes to step S1202. When the reference voltage Vba is not “0”, the process flow goes to step S1205.

When the reference voltage Vba is “0”, the control unit 1031 determines whether one or more data pieces (acquired data) of the output voltage or the output current from the PV panels 1010 in the photovoltaic power generation system 1100 are stored, for example, in the RAM 1033. When it is determined that the acquire data is stored, the process flow goes to step S1203. When the acquired data is not stored, the process flow returns to step S1201.

When the acquired data is stored, the control unit 1031 acquires the maximum value Vpmax of the output voltage of the PV panels 1010 included in the acquired data (S1203).

Subsequently, the control unit 1031 determines the reference voltage Vba on the basis of the maximum value Vpmax of the output voltage of the PV panels 1010 and the number of PV panels 1010 in the target string (S1204). For example, the control unit 1031 multiplies the maximum value Vpmax by the number of PV panels in the target string and sets the multiplication result as the reference voltage Vba. Accordingly, even when data of the all the PV panels 1010 belonging to the PV string are not prepared, it is possible to determine the reference voltage Vba early.

When the reference voltage Vba is “0” in step S1201, the control unit 1031 determines whether the reference voltage change candidate voltage Vbatmp is “0” (S1205). When the reference voltage change candidate voltage Vbatmp is “0”, the process flow goes to step S1206. When the reference voltage change candidate voltage Vbatmp is not “0”, the process flow goes to step S1206.

When the reference voltage change candidate voltage Vbatmp is “0”, the control unit 1031 determines whether a PV string in which there is no deviation in the output voltage or the output current of the PV panels 1010 belonging to the PV string is present (S1206). When there is no deviation, it means, for example, that the standard deviation of the output voltage or the output current of the plural PV panels 1010 included in the PV string is less than a predetermined value.

When a PV string in which there is no deviation is not present, the control unit 1031 ends the process of determining the reference voltage Vba. In this case, the reference voltage Vba used already is continuously used.

When a PV string in which there is no deviation is present, the control unit 1031 calculates the total sum of the output voltage of the PV panels 1010 belonging to the PV string in which there is no deviation as the reference voltage Vba (S1207). Accordingly, even when there is an individual difference between the PV panels 1010, a reference voltage Vba as high as possible in a range of equal to or more than the maximum output voltage Vmax can be calculated with higher accuracy. It is preferable that the total sum of the output voltage of all the PV panels 1010 belonging to the PV string in which there is no deviation be calculated, but some data may not be prepared.

When the reference voltage change candidate voltage Vbatmp is “0” in step S1205, the control unit 1031 determines the reference voltage change candidate voltage Vbatmp as the reference voltage Vba (S1208). By using the reference voltage Vba determined from the reference voltage change candidate voltage Vbatmp, the desired output voltage Vpx of the MPPT slave device 1020 connected to Panelx described above can be prevented from exceeding the maximum output voltage Vmax.

Subsequently, the control unit 1031 resets the reference voltage change candidate voltage Vbatmp to “0” (S1209) and ends the process of determining the reference voltage Vba.

The MPPT master device 1030 determines the output voltages of the MPPT slave devices 1020 connected to a PV panel 1010 on the basis of the amount of power generated in the PV panel 1010. Accordingly, the output voltages of the MPPT slave devices 1020 when the MPPT slave devices 1020 fix the PWM value can be determined. Therefore, the MPPT slave devices 1020 can be controlled so as to improve the power generation efficiency of the PV panel 1010. As a result, the power conditioner 1050 can recognize the maximum operating point with high accuracy.

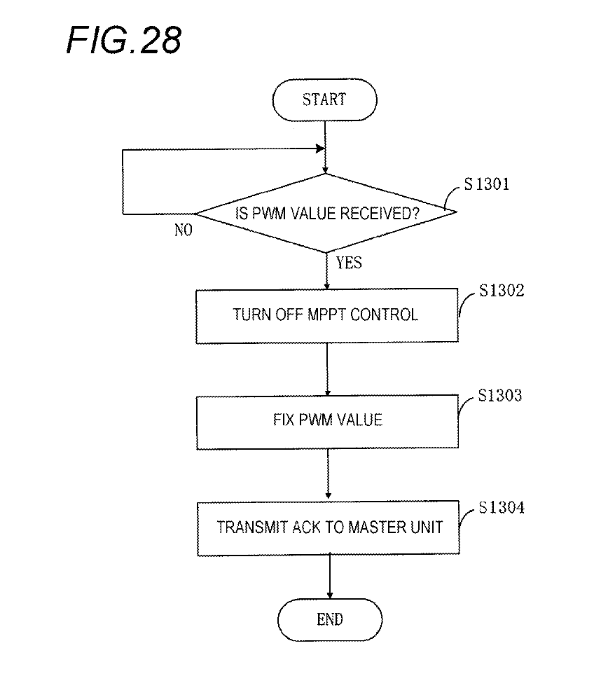

The operation example of an MPPT slave device 1020 will be described below. FIG. 28 is a flowchart illustrating the operation example of an MPPT slave device 1020. The MPPT slave device 1020 is performing the MPPT control before performing the process shown in FIG. 28.

First, the communication unit 1027 receives information of a PWM value from the MPPT master device 1030 (S1301). The PWM value is a PWM value determined, for example, in step S1115 of FIG. 23 and in step S1134 of FIG. 25. When the communication unit 1027 receives the PWM value, the process flow goes to step S1302. When receiving the PWM value, the control unit 1026 recognizes that the own MPPT slave device is the string master 1020ST.

Subsequently, the control unit 1026 stops (turns off) the MPPT control in operation (S1302). Accordingly, the following of the maximum power point in the string master 1020ST is stopped.

Subsequently, the control unit 1026 sets the PWM value for controlling the ON and OFF states of the switch unit 1025S of the DC-DC unit 1025 to the PWM value from the MPPT master device 1030. The MPPT control is stopped and the PWM value is set to a fixed value (S1303).

Subsequently, the communication unit 1027 transmits an ACK in response to the receiving of the PWM value to the MPPT master device 1030 (S1304).

The MPPT slave device 1020 can set the PWM value from the MPPT master device 1030 and can convert the output voltage to a desired output voltage. The MPPT slave device 1020 as the string master 1020ST stops the MPPT control and sets the PWM value to a fixed value. Therefore, the power conditioner 1050 can recognize the maximum operating point in all the PV panels 1010 in the target string.

A PV (Power-Voltage) characteristic detected by an MPPT slave device 1020 will be described below.

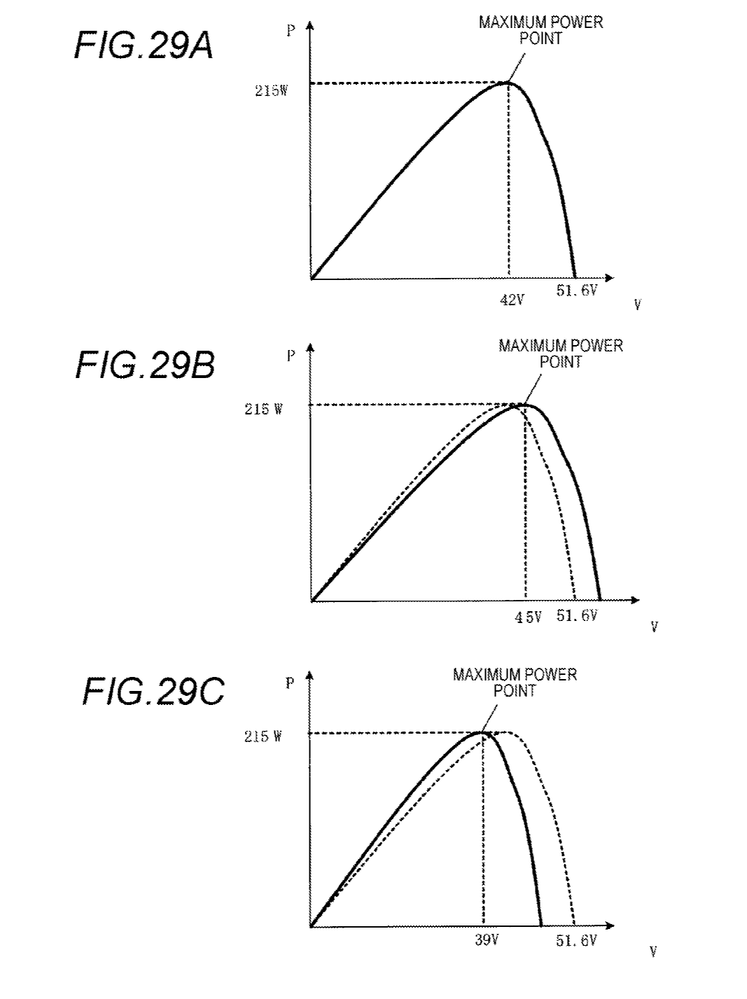

FIG. 29A is a diagram illustrating an example of the PV characteristic when an MPPT slave device 1020 fixes the PWM value of the switch unit 1025S of the DC-DC unit 1025 without performing the MPPT control. That is, this drawing shows a characteristic example when the MPPT slave device 1020 operates as a string master 1020ST. By fixing the PWM value, one maximum power point appears. The characteristic shown in FIG. 29A is the same as the characteristic shown in FIG. 31B illustrating the PV characteristic when the MPPT control is not performed.

FIG. 29B is a diagram illustrating an example of a PV characteristic when an MPPT slave device 1020 changes the duty cycle in the MPPT control to raise a voltage. In FIG. 29B, in comparison with the PV characteristic (dotted line in FIG. 29B) shown in FIG. 29A, the maximum power point moves toward a high voltage and the maximum power does not vary.

FIG. 29C is a diagram illustrating an example of a PV characteristic when an MPPT slave device 1020 changes the duty cycle in the MPPT control to lower a voltage. In FIG. 29C, in comparison with the PV characteristic (dotted line in FIG. 29C) shown in FIG. 29A, the maximum power point moves toward a low voltage and the maximum power does not vary.

The MPPT slave device 1020 can arbitrarily set the maximum power point when performing the MPPT control, as shown in FIGS. 29B and 29C.

A PV characteristic detected by the power conditioner 1050 will be described below.

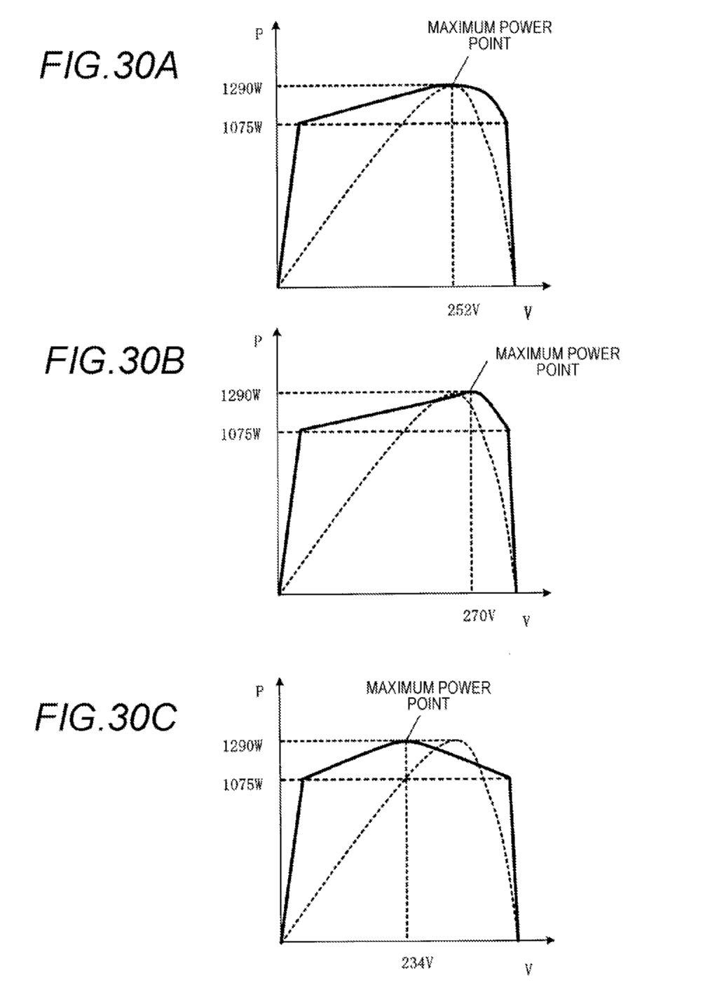

FIG. 30A is a diagram illustrating an example of a PV characteristic when the power conditioner 1050 performs MPPT control in the photovoltaic power generation system 1100 including a string master 1020ST. Here, in an arbitrary string, it is assumed that the string master 1020ST does not perform the MPPT control but operates with the PWM value fixed and the MPPT slave devices 1020 other than the string master 1020ST perform the MPPT control and operate with the PWM value variable.

FIG. 30A shows a result in a string including one string master 1020ST and five MPPT slave devices 1020 other than the string master 1020ST. That is, the characteristic shown in FIG. 30A is the same as the characteristic in which one PV characteristic shown in FIG. 29A and five PV characteristics shown in FIG. 31C in which the maximum power point appears flat are combined. In FIG. 30A, the maximum power point is determined to be one point.

FIG. 30B is a diagram illustrating an example of a PV characteristic when a string including one MPPT slave device 1020 (string master ST) of which the PWM value is raised and fixed and five MPPT slave devices 1020 performing the MPPT control is seen from the power conditioner 1050. In FIG. 30B, in comparison with the PV characteristic (dotted line in FIG. 30B) shown in FIG. 30A, the maximum power point moves toward a high voltage and the maximum power does not vary. The maximum power point is determined to be one point.

FIG. 30C is a diagram illustrating an example of a PV characteristic when a string including one MPPT slave device 1020 (string master ST) of which the PWM value is lowered and fixed and five MPPT slave devices 1020 performing the MPPT control is seen from the power conditioner 1050. In FIG. 30C, in comparison with the PV characteristic (dotted line in FIG. 30C) shown in FIG. 30A, the maximum power point moves toward a low voltage and the maximum power does not vary. The maximum power point is determined to be one point.

Therefore, even when the MPPT control result of the MPPT slave devices 1020 includes a slight error (for example, the conversion loss of the DC-DC unit 1025) in comparison with an ideal value, the power conditioner 1050 can surely recognize the maximum operating point from the PV characteristics shown in FIGS. 30A to 30C. Therefore, since the accuracy of the tracking control of the maximum operating point is improved, it is possible to further improve the power generation efficiency of the respective PV panels 1010. The power generation efficiency of the PV panels 1010 includes the voltage conversion efficiency in the MPPT slave devices 1020.

The present invention is not limited to the configuration of the second embodiment, and any configuration may be employed as long as it can achieve the functions described in the appended claims or the functions of the configuration of the second embodiment.

It is stated above in the second embodiment that information on the PWM value is mainly transmitted as the power generation control information between the MPPT slave devices 1020 and the MPPT master device 1030, but, for example, information on a voltage value may be transmitted. For example, the MPPT master device 1030 may transmit the desired output voltages VP and Vpx to the MPPT slave devices 1020. The MPPT slave devices 1020 may receive the desired output voltage Vp and Vpx and may determine the PWM value from the input-side detected voltage value and the desired output voltages Vp and Vpx.

In the second embodiment, the string master 1020ST is determined in the unit of PV string, but a string in which a string master 1020ST is not present may be present in the photovoltaic power generation system 1100. The power conditioner 1050 recognizes a characteristic in which the characteristics shown in FIGS. 30A to 30C for each PV string are combined. Therefore, when a string in which the string master 1020ST is not present is included, the difference between the maximum power point and the minimum power point in the MPPT control is reduced but the maximum power point can be recognized.

In the above-mentioned second embodiment, plural string masters 1020ST may be present in the same PV string. Accordingly the difference between the maximum power point and the minimum power point in the MPPT control increases and it is thus possible to easily recognize the maximum power point.

A summary of aspects of the present invention is shown as follows.

There is provided a power generation control device to be electrically connected to a photovoltaic panel for controlling an output voltage of the photovoltaic panel, the power generation control device including: a scanning unit, configured to perform a scanning process in which the output voltage of the photovoltaic panel is sequentially changed in a predetermined voltage range, wherein the predetermined voltage range is changed in accordance with the photovoltaic panel.

The power generation control device may be configured so that the scanning unit is configured to determine a changing direction of the output voltage of the photovoltaic panel based on a magnitude relationship between a voltage for ending the scanning process and the output voltage of the photovoltaic panel at a time of starting the scanning process.

The power generation control device may be configured so that the scanning unit is configured to end the scanning process when a ratio reaches a first predetermined value, wherein the ratio indicates a ratio of an output power of the photovoltaic panel at a current operating voltage to an output power of the photovoltaic panel at a time of starting the scanning process.

The power generation control device may be configured so that the scanning unit is configured to set a first voltage as a voltage for ending the scanning process when a first ratio is larger than a second predetermined voltage and a second ratio is substantially the same as a third predetermined value in the scanning process, wherein the first voltage indicates a voltage of a maximum output power point of the photovoltaic panel, the first ratio indicates a ratio of a voltage of a maximum power point by a maximum power point tracking control to an open voltage of the photovoltaic panel, and the second ratio indicates a ratio of the first voltage to the voltage of the maximum power point by the maximum power point tracking control.

The power generation control device may be configured so that the scanning unit is configured to set an open voltage of the photovoltaic panel as a voltage for ending the scanning process when a ratio is equal to or less than a predetermined value in the scanning process, wherein the ratio indicates a ratio of a voltage of a maximum power point by a maximum power point tracking control to the open voltage of the photovoltaic panel.

The power generation control device may be configured so that the scanning unit is configured to set a voltage sent from another control device as a voltage for ending the scanning process.

The power generation control device may be configured so that the scanning unit is configured to start a next scanning process with reference to a voltage of a maximum output power point of the photovoltaic panel acquired in the scanning process.

The power generation control device may be configured by further including a maximum power point tracking control unit, configured to start a maximum power point tracking control with reference to a voltage of a maximum output power point of the photovoltaic panel acquired in the scanning process.

The power generation control device may be configured so that the scanning unit is configured to perform a first scanning process in a first voltage range, and to perform a second scanning process in a second voltage range narrower than the first voltage range based on a result of the first scanning process.

The power generation control device may be configured by further including a local maximum power point estimating unit, configured to estimate a local maximum power point from a voltage-power characteristic which indicates a relationship between an on voltage and an output power of the photovoltaic panel acquired in the first scanning process.

The power generation control device may be configured so that the scanning unit is configured to perform the scanning process when a ratio is larger than a predetermined value, wherein the ratio indicates a ratio of a maximum power point of the photovoltaic panel to an open voltage of the photovoltaic panel.

The power generation control device may be configured so that the scanning unit is configured to perform the scanning process in a voltage range from an output voltage of the photovoltaic panel at a time of starting the scanning process to a substantial half of a voltage of the maximum power point of the photovoltaic panel.

There is also provided a photovoltaic power generation system, including: a power generation control device for controlling a photovoltaic panel; and a control device for controlling the power generation control device, wherein the control device is configured to transmit a start request to the power generation control device, wherein the start request is provided to request the power generation control device to perform a scanning process in which an output voltage of the photovoltaic panel is sequentially changed, and the power generation control device includes: a receiving unit, configured to receive the start request from the control device; and a scanning unit, configured to perform the scanning process in a predetermined voltage range in response to the start request, wherein the predetermined voltage range is changed in accordance with the photovoltaic panel.

The photovoltaic power generation system may be configured so that the photovoltaic power generation system is further provided with a string in which a plurality of photovoltaic panels are serially connected, the power generation control device includes a voltage converting unit, configured to convert the output voltage of the photovoltaic panel, and the power generation control device is connected to each of the photovoltaic panels, and at least one of a plurality of power generation control devices which constitute the string is configured to fix a duty cycle of the voltage converting unit at a value transmitted by the control device.

There is also provided a power generation control method in a power generation control device including: performing a scanning process in which an output voltage of a photovoltaic panel is sequentially changed in a predetermined voltage range, wherein the predetermined voltage range is changed in accordance with the photovoltaic panel.

In addition, configurations of other aspects of the present invention will be presented as follows.

(1) A photovoltaic power generation system, including:

a plurality of power generation control devices for controlling a plurality of photovoltaic panels which are connected in serial or parallel; and

a control device for controlling the plurality of power generation control devices, wherein

the control device includes:

an output voltage determining unit, configured to determine an output voltage of a power generation control device which controls an arbitrary photovoltaic panel included in the plurality of photovoltaic panels based on an output power of the arbitrary photovoltaic panel; and

a transmitting unit, configured to transmit a power generation control information generated based on the output voltage determined by the output voltage determining unit, to the power generation control device which controls the arbitrary photovoltaic panel, and

the power generation control device which controls the arbitrary photovoltaic panel includes:

a voltage converting unit, configured to convert the output voltage of the photovoltaic panel;

a voltage conversion control unit, configured to control a duty cycle which indicates a ratio of an ON time and an OFF time of a switch included in the voltage converting unit; and

a receiving unit, configured to receive the power generation control information from the control device, wherein

the voltage conversion control unit is configured to fix the duty cycle based on the power generation control information received by the receiving unit.

(2) The photovoltaic power generation system according to the configuration (1), wherein

the control device further includes a master determining unit, configured to determine a power generation control device, the duty cycle of which is fixed, as a master based on a statistical value of output voltages of the plurality of photovoltaic panels, and

the output voltage determining unit of the control device is configured to determine an output voltage of the master based on the output power of the photovoltaic panel controlled by the master, and

the transmitting unit of the control device is configured to transmit the power generation control information to the master.

(3) The photovoltaic power generation system according to the configuration (2), wherein

the master determining unit of the control device is configured to determine, as the master, a power generation control device which controls a photovoltaic panel, an output power of which is equal to or larger than a predetermined power when differences of outputs of the photovoltaic panels are equal to or more than a predetermined value.

(4) The photovoltaic power generation system according to the configuration (2) or (3), wherein

a photovoltaic string is formed to serially connect the plurality of photovoltaic panels, and

the master determining unit of the control device is configured to determine the master for each photovoltaic string.

(5) The photovoltaic power generation system according to the configuration (4), wherein

the voltage conversion control unit of the power generation control device which controls a photovoltaic panel included in the photovoltaic string is configured to cause the duty cycle to be variable when a difference is equal to or less than a predetermined value, wherein the difference indicates a difference between a total sum of output voltages of photovoltaic panels included in the photovoltaic string and a predetermined reference voltage.

(6) The photovoltaic power generation system according to the configuration (5), wherein

the output voltage determining unit of the control device is configured to determine an output voltage of the master based on output powers of the photovoltaic panels in the photovoltaic string, the reference voltage and an output voltage of the photovoltaic panel which is controlled by the master.

(7) The photovoltaic power generation system according to the configuration (5) or (6), wherein

the control device further includes a reference voltage determining unit, configured to determine the reference voltage based on an output voltage of the power generation control device which controls photovoltaic panels, output powers of which are equal to or more than a predetermined power, included in the photovoltaic string and on the number of the photovoltaic panels.

(8) The photovoltaic power generation system according to the configuration (5) or (6), wherein

the control device further includes a reference voltage determining unit, configured to determine the reference voltage based on output powers of photovoltaic panels which are included in the photovoltaic string, an output power of a predetermined photovoltaic panel, and an output voltage determined by the voltage determining unit which is larger than a maximum voltage which can be output from a power generation control device which controls the predetermined photovoltaic panel.

(9) The photovoltaic power generation system according to the configuration (5) or (6), wherein

the control device further includes a reference voltage determining unit, configured to determine the reference voltage based on a total sum of output voltages of photovoltaic panels included in the photovoltaic string when differences of outputs of the photovoltaic panels are equal to or less than a predetermined value.

(10) The photovoltaic power generation system according to any one of the configurations (2) to (9), wherein

the master determining unit is configured to clear the master when the output power of the photovoltaic panel connected to the master goes beyond a predetermined range from the output power of the photovoltaic panel connected to the master at a time of determining the master.

(11) The photovoltaic power generation system according to any one of the configurations (2) to (9), wherein

the master determining unit is configured to clear the master when a predetermined time passes from a time of determining the master.

(12) The photovoltaic power generation system according to any one of the configurations (1) to (11), wherein

the control device further includes:

a receiving unit, configured to receive information on an output of the photovoltaic panel controlled by the power generation control device from the power generation control device; and

a duty cycle determining unit, configured to determine the duty cycle based on the output voltage of the power generation control device determined by the output voltage determining unit and on the information on the output of the photovoltaic panel, wherein

the power generation control information includes information on the duty cycle.

(13) The photovoltaic power generation system according to any one of the configurations (1) to (11), wherein

the power generation control information includes information on the output voltage determined by the output voltage determining unit.

(14) A power generation control device for controlling photovoltaic panels which are connected in serial or parallel, the power generation control device including:

a voltage converting unit, configured to convert an output voltage of the photovoltaic panel;

a voltage conversion control unit, configured to control a duty cycle which indicates a ratio of an ON time and an OFF time of a switch included in the voltage converting unit; and

a receiving unit, configured to receive power generation control information from an external control device, wherein the power generation control information is generated based on an output voltage of the power generation control device determined by the external control device, wherein

the voltage conversion control unit is configured to fix the duty cycle based on the power generation control information received by the receiving unit.

(15) A control device for controlling a plurality of power generation control devices for controlling a plurality of photovoltaic panels which are connected in serial or parallel, the control device including:

an output voltage determining unit, configured to determine an output voltage of a power generation control device which controls an arbitrary photovoltaic panel included in the plurality of photovoltaic panels based on an output power of the arbitrary photovoltaic panel; and

a transmitting unit, configured to transmit a power generation control information generated based on the output voltage determined by the output voltage determining unit, to the power generation control device which controls the arbitrary photovoltaic panel.

(16) A power generation control method in a power generation control device for controlling photovoltaic panels which are connected in serial or parallel, the power generation control method including:

a voltage conversion control step of controlling a duty cycle which indicates a ratio of an ON time and an OFF time of a switch included in a voltage converting unit, configured to convert an output voltage of the photovoltaic panel; and

a receiving step of receiving power generation control information from an external control device, wherein the power generation control information is generated based on an output voltage of the power generation control device determined by the external control device, wherein

in the voltage conversion control step, the duty cycle is fixed based on the power generation control information received in the receiving step.

(17) A control method in a control device for controlling a plurality of power generation control devices for controlling a plurality of photovoltaic panels which are connected in serial or parallel, the control method including:

an output voltage determining step of determining an output voltage of a power generation control device which controls an arbitrary photovoltaic panel included in the plurality of photovoltaic panels based on an output power of the arbitrary photovoltaic panel; and

a transmitting step of transmitting a power generation control information generated based on the output voltage determined in the output voltage determining step, to the power generation control device which controls the arbitrary photovoltaic panel.

This application is based upon and claims the benefit of priorities of Japanese Patent Applications Nos. 2012-205076, 2012-205077 and 2012-205078 filed on Sep. 18, 2012, the contents of which are incorporated herein by reference in its entirety.

The present invention can be practically used for a power generation control device, a photovoltaic power generation system, and a power generation control method which can rapidly search for or determine a maximum power point and suppress a variation in output of a photovoltaic panel.

The present invention can be usefully used for a photovoltaic power generation system, a power generation control device, a control device, a power generation control method, and a control method which can improve power generation efficiency of a PV panel.

What is claimed is:

1. A power generation control device to be electrically connected to a photovoltaic panel for controlling an output voltage of the photovoltaic panel, the power generation control device comprising:
a scanning unit, configured to perform a scanning process in which the output voltage of the photovoltaic panel is sequentially changed in a predetermined voltage range, wherein
the predetermined voltage range is changed in accordance with the photovoltaic panel.

2. The power generation control device according to claim 1, wherein
the scanning unit is configured to determine a changing direction of the output voltage of the photovoltaic panel based on a magnitude relationship between a voltage for ending the scanning process and the output voltage of the photovoltaic panel at a time of starting the scanning process.

3. The power generation control device according to claim 1, wherein
the scanning unit is configured to end the scanning process when a ratio reaches a first predetermined value, wherein the ratio indicates a ratio of an output power of the photovoltaic panel at a current operating voltage to an output power of the photovoltaic panel at a time of staring the scanning process.

4. The power generation control device according to claim 1, wherein
the scanning unit is configured to set a first voltage as a voltage for ending the scanning process when a first ratio is larger than a second predetermined voltage and a second ratio is substantially the same as a third predetermined value in the scanning process, wherein the first voltage indicates a voltage of a maximum output power point of the photovoltaic panel, the first ratio indicates a ratio of a voltage of a maximum power point by a maximum power point tracking control to an open voltage of the photovoltaic panel, and the second ratio indicates a ratio of the first voltage to the voltage of the maximum power point by the maximum power point tracking control.

5. The power generation control device according to claim 1, wherein
the scanning unit is configured to set an open voltage of the photovoltaic panel as a voltage for ending the scanning process when a ratio is equal to or less than a predetermined value in the scanning process, wherein the ratio indicates a ratio of a voltage of a maximum power point by a maximum power point tracking control to the open voltage of the photovoltaic panel.

6. The power generation control device according to claim 1, wherein
the scanning unit is configured to set a voltage sent from another control device as a voltage for ending the scanning process.

7. The power generation control device according to claim 1, wherein
the scanning unit is configured to start a next scanning process with reference to a voltage of a maximum output power point of the photovoltaic panel acquired in the scanning process.

8. The power generation control device according to claim 1, further comprising:
a maximum power point tracking control unit, configured to start a maximum power point tracking control with reference to a voltage of a maximum output power point of the photovoltaic panel acquired in the scanning process.

9. The power generation control device according to claim 1, wherein
the scanning unit is configured to perform a first scanning process in a first voltage range, and to perform a second scanning process in a second voltage range narrower than the first voltage range based on a result of the first scanning process.

10. The power generation control device according to claim 9, further comprising:
a local maximum power point estimating unit, configured to estimate a local maximum power point from a voltage-power characteristic which indicates a relationship between an output voltage and an output power of the photovoltaic panel acquired in the first scanning process.

11. The power generation control device according to claim 1, wherein
the scanning unit is configured to perform the scanning process when a ratio is larger than a predetermined value, wherein the ratio indicates a ratio of a maximum power point of the photovoltaic panel to an open voltage of the photovoltaic panel.

12. The power generation control device according to claim 11, wherein
the scanning unit is configured to perform the scanning process in a voltage range from an output voltage of the photovoltaic panel at a time of starting the scanning process to a substantial half of a voltage of the maximum power point of the photovoltaic panel.

13. A photovoltaic power generation system, comprising:
a power generation control device for controlling a photovoltaic panel; and
a control device for controlling the power generation control device, wherein
the control device is configured to transmit a start request to the power generation control device, wherein the start request is provided to request the power generation control device to perform a scanning process in which an output voltage of the photovoltaic panel is sequentially changed, and
the power generation control device comprises:
a receiving unit, configured to receive the start request from the control device; and
a scanning unit, configured to perform the scanning process in a predetermined voltage range in response to the start request, wherein
the predetermined voltage range is changed in accordance with the photovoltaic panel.

14. The photovoltaic power generation system according to claim 13, wherein
the photovoltaic power generation system is further provided with a string which a plurality of photovoltaic panels are serially connected,
the power generation control device includes a voltage converting unit, configured to convert the output voltage of the photovoltaic panel, and the power generation control device is connected to each of the photovoltaic panels, and
at least one of a plurality of power generation control devices which constitute the string is configured to fix a duty cycle of the voltage converting unit at a value transmitted by the control device.

15. A power generation control method in a power generation control device comprising:
performing a scanning process in which an output voltage of a photovoltaic panel is sequentially changed in a predetermined voltage range, wherein
the predetermined voltage range is changed in accordance with the photovoltaic panel.
